(19) United States
(12) Patent Application Publication
(10) Pub. No.: US 2016/0357354 A1
(43) Pub. Date: Dec. 8, 2016

(54) CONDITION-BASED ACTIVATION OF A USER INTERFACE

(71) Applicant: Apple Inc., Cupertino, CA (US)

(72) Inventors: Kevin Will CHEN, Sunnyvale, CA (US); Christopher WILSON, San Francisco, CA (US); Lawrence Y. YANG, San Francisco, CA (US); Alan C. DYE, San Francisco, CA (US); Jonathan P. IVE, San Francisco, CA (US)

(21) Appl. No.: 14/846,511

(22) Filed: Sep. 4, 2015

Related U.S. Application Data
(60) Provisional application No. 62/171,191, filed on Jun. 4, 2015.

(51) Int. Cl. G06F 3/0481; G06F 3/16

(52) U.S. Cl. CPC G06F 3/0481; G06F 3/167

(57) ABSTRACT

The present disclosure relates to techniques for accessing modes of operation and techniques for providing an alarm interface for electronic devices. In some embodiments, a device detects that a battery is being charged and that the device is oriented in a predefined orientation. In accordance with the detection that the battery is being charged and that the device is oriented in the predefined orientation, the device activates a predefined mode of operation. In some embodiments, a device displays a first user interface object in a first color, and, at a predetermined time, the device displays the first user interface object in a second color and displays an option for dismissing an alarm, wherein the option for dismissing is displayed as a second user interface object located at a portion of a display of the device proximate to a hardware button of the device.

### RELATED APPLICATIONS

This application claims benefit of U.S. Provisional Patent Application No. 62/171,191, entitled “Condition-Based Activation of a User Interface,” filed on Jun. 4, 2015, the entirety of which is hereby incorporated by reference in its entirety.

### FIELD

The present disclosure relates generally to computer user interfaces, and more specifically to techniques for initiating and displaying user interfaces configured to be used in different circumstances.

### BACKGROUND

Users of multifunction and/or multimodal portable electronic devices may require access to certain functions and interfaces, such as alarm clock functions, interfaces, or modes. Additionally, users of wearable portable electronic devices may benefit from special interfaces configured for use in different circumstances.

### BRIEF SUMMARY

Some techniques for providing, activating, and interacting with alarm clock interfaces in portable electronic devices are cumbersome and inefficient. For example, existing techniques may require a user to execute several inputs and to navigate a complex series of nested menus in order to access an alarm clock interface of an electronic device. Existing techniques for exiting or deactivating an alarm clock mode or an alarm clock interface may further require one or more explicit inputs from a user, such as touch inputs or actuation of hardware buttons. The present invention recognizes that existing techniques for accessing alarm clock interfaces may be particularly cumbersome and ineffective when a user attempts to access such an interface in a darkened environment, such as in a bedroom at night. Accessing the interface may, for example, require a series of precise inputs to activate a device, unlock a screen, and activate an alarm clock interface, all of which may be difficult to execute in a dark environment when a user is tired. Furthermore, existing techniques for accessing and navigating user interfaces for wearable electronic devices are unconducive to use when the device is not being worn by a user. Wearable devices may be optimized to receive inputs that are most comfortable and effective when the device is being worn, and such inputs may be cumbersome, inefficient, and ineffective when the wearable device is not being worn. Existing techniques are imprecise and inefficient, requiring more complex and cumbersome inputs and more time than necessary, which wastes user time and device energy. This latter consideration is particularly important in battery-operated devices.

Accordingly, the present inventions provides, inter alia, the benefit of portable electronic devices with faster, more efficient, less cumbersome methods and interfaces for providing, activating, and interacting with alarm clock interfaces. Furthermore, the invention provides wearable electronic devices with faster, more efficient, less cumbersome methods and interfaces for accessing and navigating user interfaces when the device is not being worn by a user. Specifically, an aspect of the invention provides improved methods for activating an alarm clock when a wearable electronic device is resting on a nightstand, and there is a need for improved methods for interacting with a wrist-wearable electronic device when it is resting on a surface rather than being worn on the wrist of a user.

Such methods and interfaces optionally complement or replace other methods for providing, activating, and interacting with alarm clock interfaces and for accessing and navigating user interfaces when a wearable electronic device is not being worn by a user. Such methods and interfaces reduce the cognitive burden on a user and produce a more efficient human-machine interface, including by automatically activating an alarm clock interface when a device is resting on a nightstand, such as to be charged at night. Such methods and interfaces may further reduce the cognitive burden on a user and produce a more efficient human-machine interface by displaying interfaces oriented and optimized to be displayed when a wrist-wearable device is resting on its side in a darkened environment, rather than being worn on the wrist of a user in a bright environment. Such methods and interfaces may further reduce the cognitive burden on a user and produce a more efficient human-machine interface by being configured to accept user inputs that are comfortable, easy, and effective to apply to a wrist-wearable device when the wrist-wearable device is resting on a surface rather than being worn on a wrist. Such methods and interfaces may also reduce the number of unnecessary, extraneous, repetitive, and/or redundant inputs, and may create a faster and more efficient user interface arrangement, which may reduce the number of required inputs, reduce processing power, and reduce the amount of time for which user interfaces need to be displayed in order for desired functions to be accessed and carried out. For battery-operated computing devices, such methods and interfaces conserve power and increase the time between battery charges (and decrease the time to fully charge a battery), including by reducing unnecessary or accidental inputs and by obviating unnecessary extra user inputs.

The above deficiencies and other problems are reduced or eliminated by the disclosed devices, methods, and computer-readable media. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch screen display”). In some embodiments, the device has hardware input mechanisms such as depressible buttons and/or rotatable input mechanisms. In some embodiments, the device has a graphical user interface (GUI), one or more processors, memory, and one or more modules, programs, or sets of instructions stored in the memory for performing multiple functions. In some embodiments, the user interacts with the GUI through finger contacts and gestures on the touch-sensitive surface and/or through rotating the rotatable input mechanism and/or through depressing hardware buttons. In some embodiments, the functions optionally include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

In accordance with some embodiments, a method is performed at an electronic device with a display, a battery, and one or more processors, the method comprising: detecting that the battery is being charged; detecting that the device is oriented in a predefined orientation; and in accordance with the detection that the battery is being charged and the detection that the device is oriented in the predefined orientation, activating a predefined mode of operation.

In some embodiments, a method is performed at an electronic device with a display, a hardware button, and one or more processors, the method comprising: displaying a first user interface object in a first color; at a predetermined time: displaying the first user interface object in a second color; and displaying an option for dismissing an alarm, wherein the option for dismissing is displayed as a second user interface object located at a portion of the display proximate to the hardware button.

In some embodiments, non-transitory computer-readable storage medium comprises instructions for: detecting that the battery is being charged; detecting that the device is oriented in a predefined orientation; and in accordance with the detection that the battery is being charged and the detection that the device is oriented in the predefined orientation, activating a predefined mode of operation.

In some embodiments, transitory computer-readable storage medium comprises instructions for: detecting that the battery is being charged; detecting that the device is oriented in a predefined orientation; and in accordance with the detection that the battery is being charged and the detection that the device is oriented in the predefined orientation, activating a predefined mode of operation.

In some embodiments, a device comprises a display; a battery; one or more processors; and memory storing instructions that, when executed by the one or more processors, cause the one or more processors to: detect that the battery is being charged; detect that the device is oriented in a predefined orientation; and in accordance with the detection that the battery is being charged and the detection that the device is oriented in the predefined orientation, activate a predefined mode of operation.

In some embodiments, a device comprises means for detecting that the battery is being charged; and means for detecting that the device is oriented in a predefined orientation; and means for, in accordance with the detection that the battery is being charged and the detection that the device is oriented in the predefined orientation, activating a predefined mode of operation.

In some embodiments, a non-transitory computer-readable storage medium comprises instructions for: displaying a first user interface object in a first color; at a predetermined time: displaying the first user interface object in a second color; and displaying an option for dismissing an alarm, wherein the option for dismissing is displayed as a second user interface object located at a portion of the display proximate to the hardware button.

In some embodiments, a transitory computer-readable storage medium comprises instructions for: displaying a first user interface object in a first color; at a predetermined time: displaying the first user interface object in a second color; and displaying an option for dismissing an alarm, wherein the option for dismissing is displayed as a second user interface object located at a portion of the display proximate to the hardware button.

In some embodiments, a device comprises a display; a hardware button; one or more processors; and memory storing instructions that, when executed by the one or more processors, cause the one or more processors to: display a first user interface object in a first color; at a predetermined time: display the first user interface object in a second color; and display an option for dismissing an alarm, wherein the option for dismissing is displayed as a second user interface object located at a portion of the display proximate to the hardware button.

In some embodiments, a device comprises means for displaying a first user interface object in a first color; and means for, at a predetermined time: displaying the first user interface object in a second color; and displaying an option for dismissing an alarm, wherein the option for dismissing is displayed as a second user interface object located at a portion of the display proximate to the hardware button.

In some embodiments, an electronic device comprises a display unit; a battery unit; a processing unit coupled to the display unit and the battery unit configured to: detect that the battery unit is being charged; detect that the device is oriented in a predefined orientation; and in accordance with the detection that the battery unit is being charged and the detection that the device is oriented in the predefined orientation, activate a predefined mode of operation.

In some embodiments, an electronic device comprises: a display unit; a hardware button unit; and a processing unit coupled to the display unit and the hardware button unit configured to: enable display on the display unit of a first user interface object in a first color; at a predetermined time: enable display on the display unit of the first user interface object in a second color; and enable display on the display unit of an option for dismissing an alarm, wherein the option for dismissing is displayed as a second user interface object located at a portion of the display unit proximate to the hardware button unit.

Thus, devices are provided with faster, more efficient, less cumbersome methods and interfaces for providing, activating, and interacting with alarm clock interfaces, and for accessing and navigating user interfaces when a wearable device is not being worn by a user; these devices, methods, and interfaces thereby increase the effectiveness, efficiency, and user satisfaction with such devices. Such methods and interfaces optionally complement or replace other methods for providing, activating, and interacting with alarm clock interfaces and for accessing and navigating user interfaces when a wearable device is not being worn by a user.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A and 6B illustrate a personal electronic device in accordance with some embodiments.

FIGS. 6C-6M illustrate exemplary user interfaces in accordance with some embodiments.

FIGS. 7A-7C are flow diagrams illustrating methods of activating a mode of operation in accordance with some embodiments.

FIGS. 8A-8B are flow diagrams illustrating methods of displaying a user interface accordance with some embodiments.

FIG. 9 is a functional block diagram of an electronic device in accordance with some embodiments.

FIG. 10 is a functional block diagram of an electronic device in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for providing, activating, and interacting with alarm clock interfaces and for accessing and navigating user interfaces when a wearable device is not being worn by a user. The embodiments described herein improve on current methods by allowing for efficient, convenient, fast, and intuitive ways of providing, activating, and interacting with alarm clock interfaces, and for accessing and navigating user interfaces when a wearable device is not being worn by a user. Such techniques can reduce the cognitive burden on a user who accesses user interfaces, including alarm clock user interfaces, thereby enhancing productivity. Further, such techniques can reduce processor and battery power otherwise wasted on redundant user inputs.

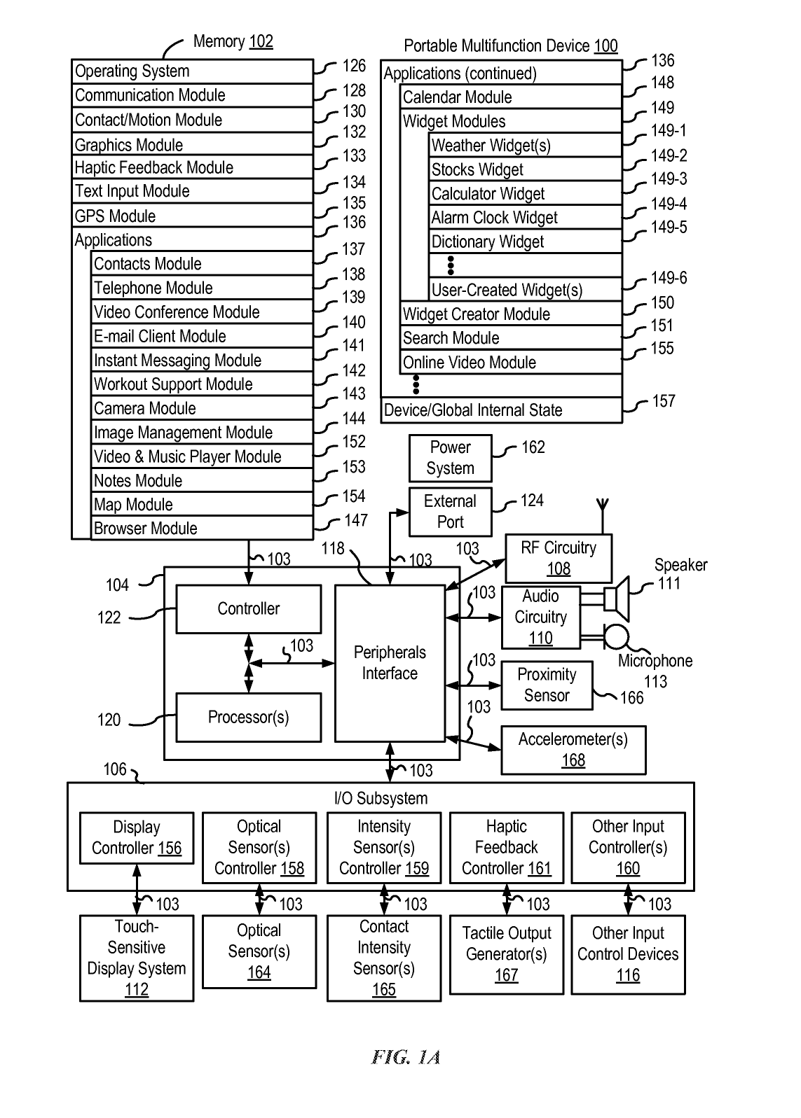

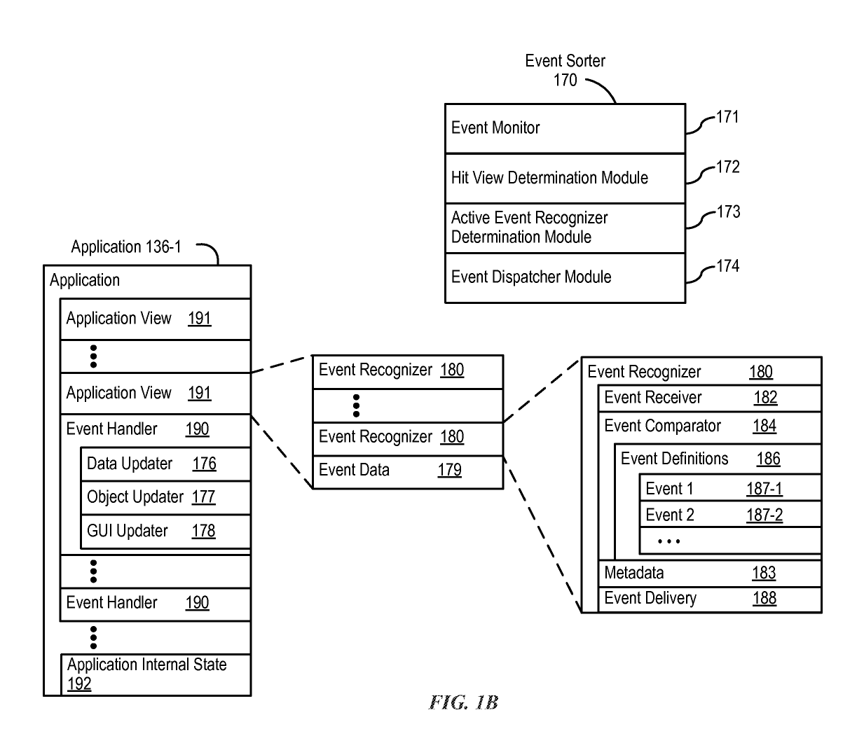

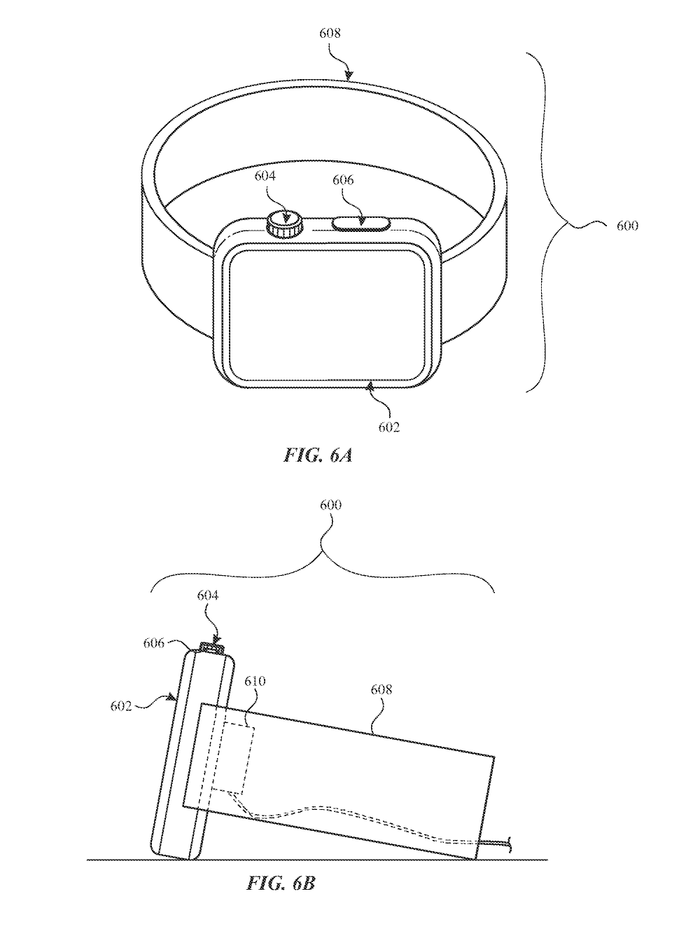

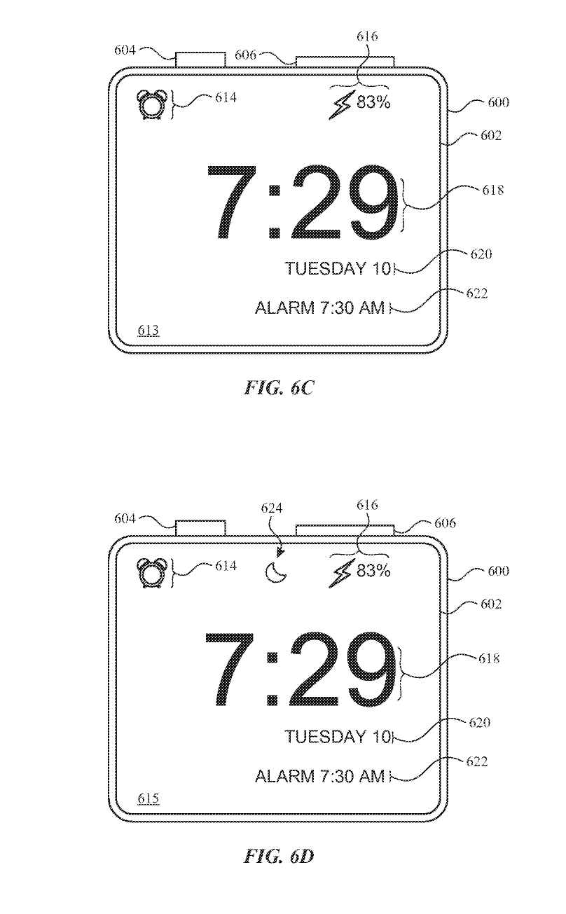

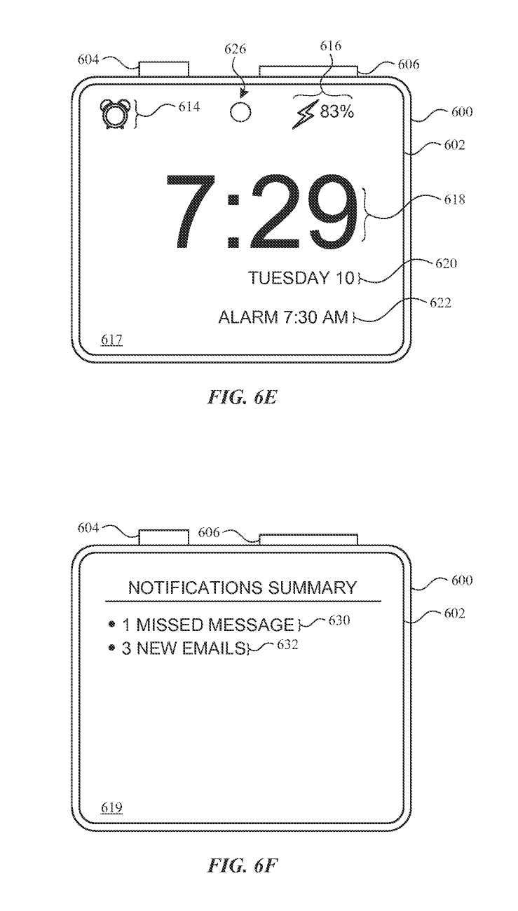

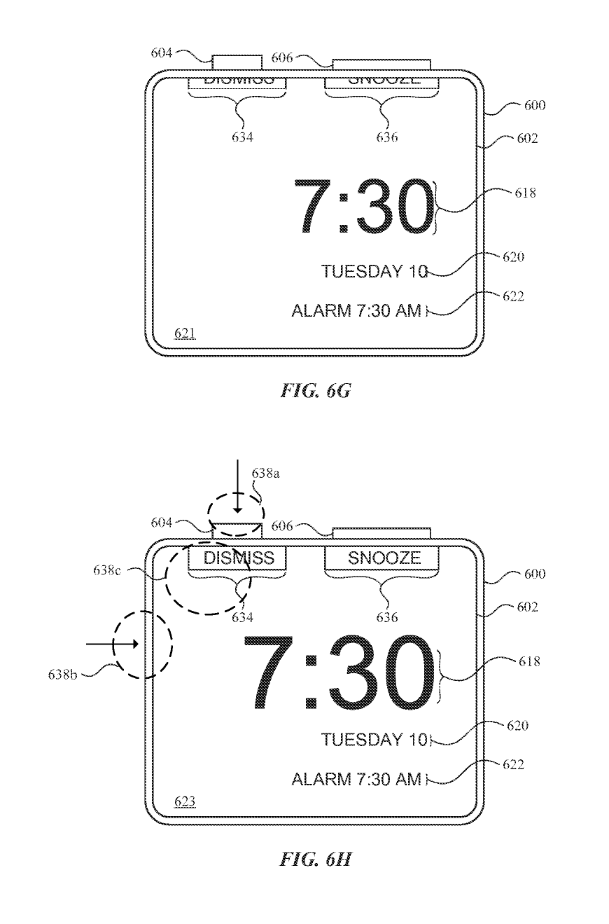

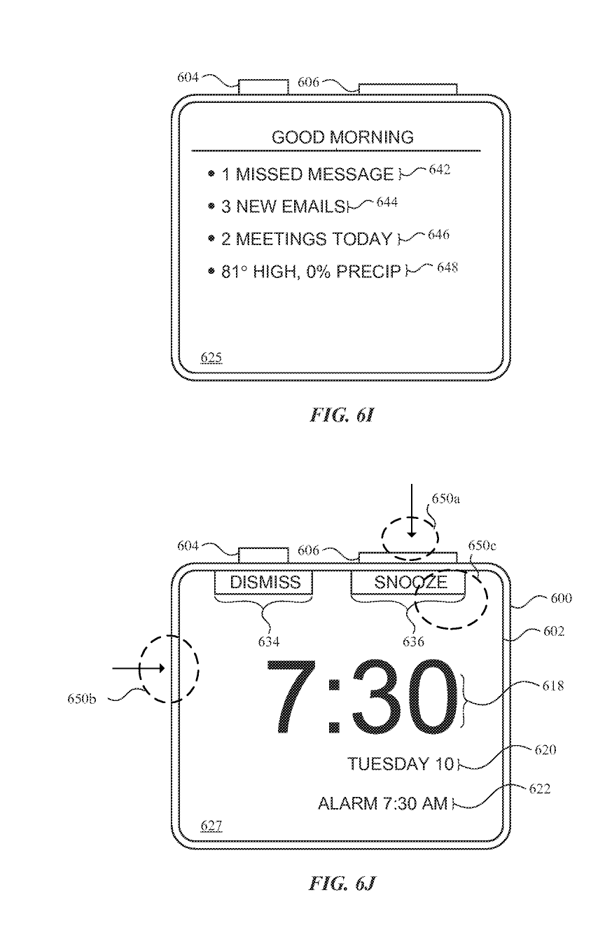

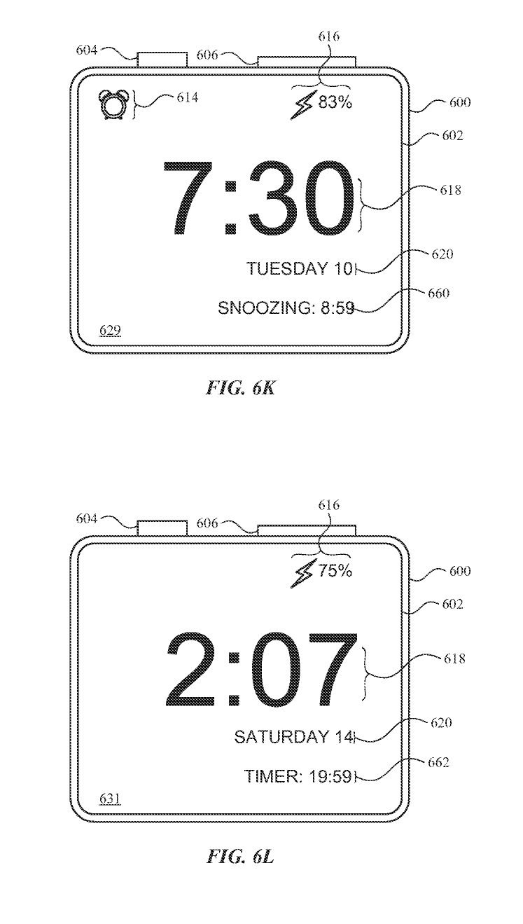

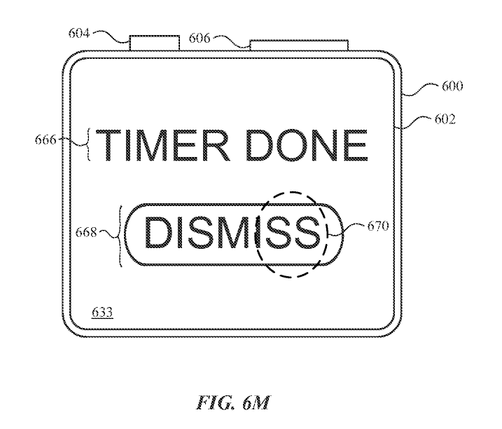

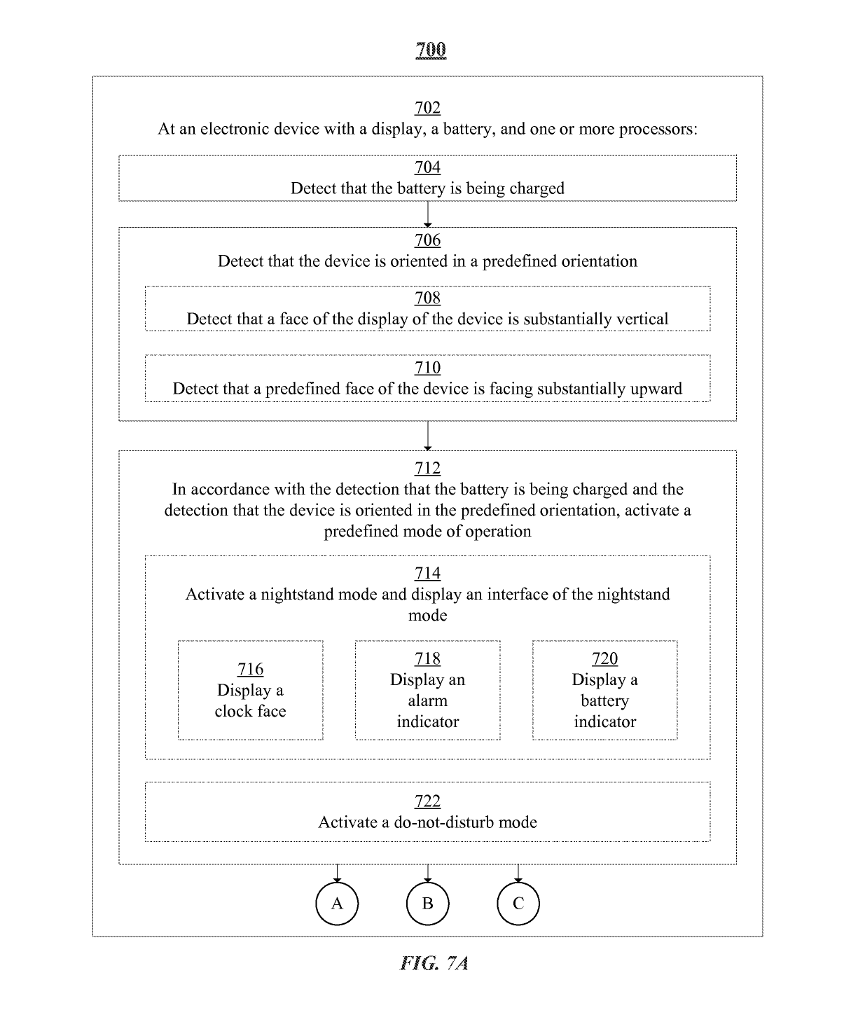

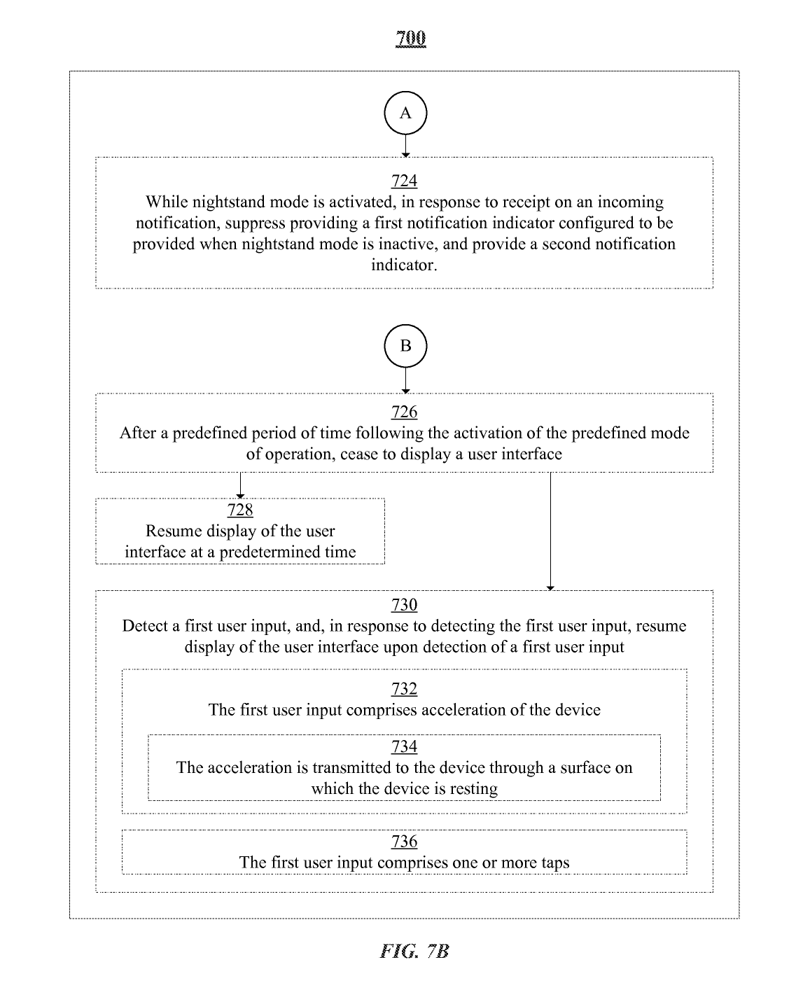

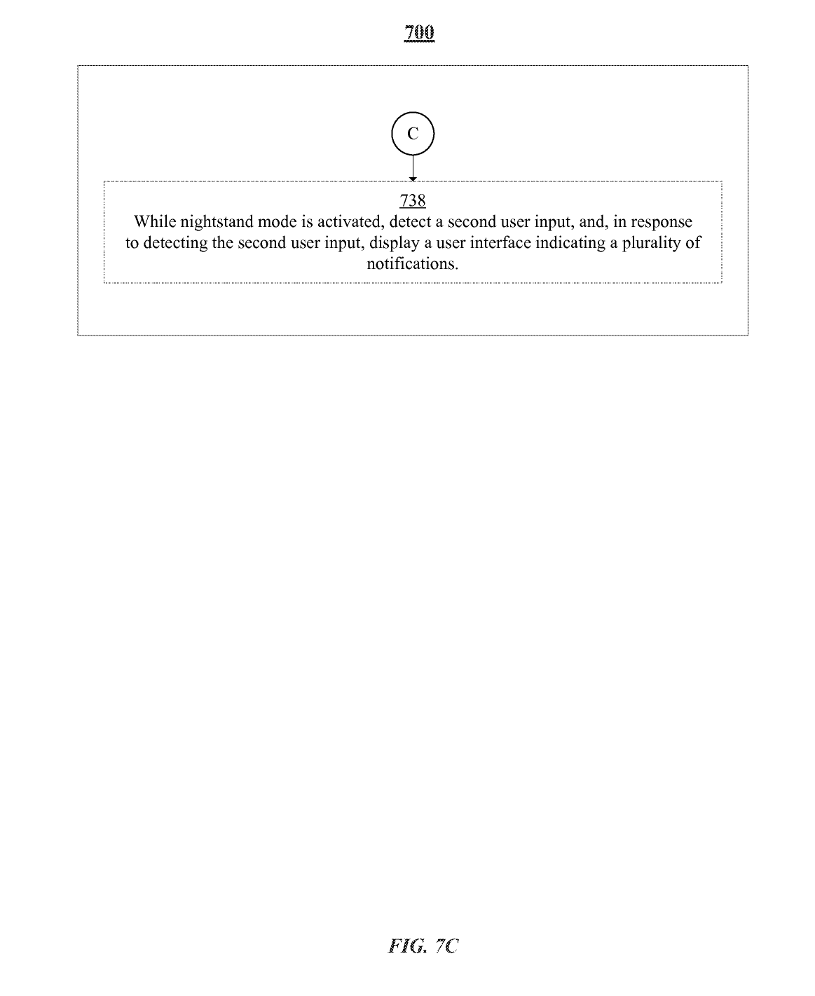

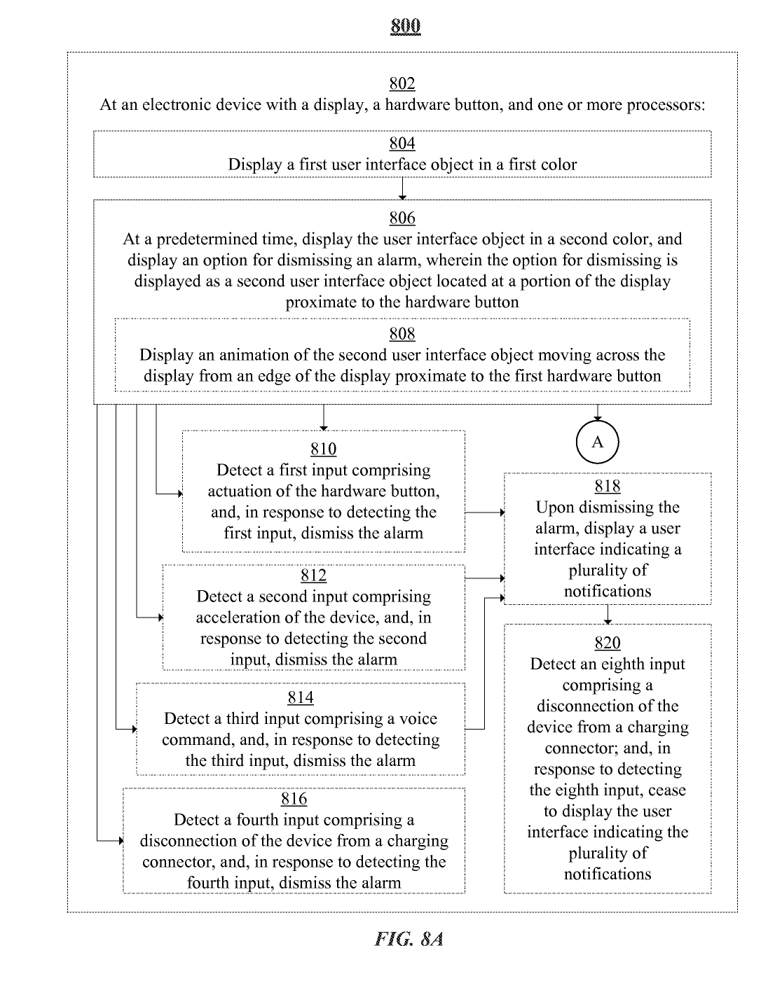

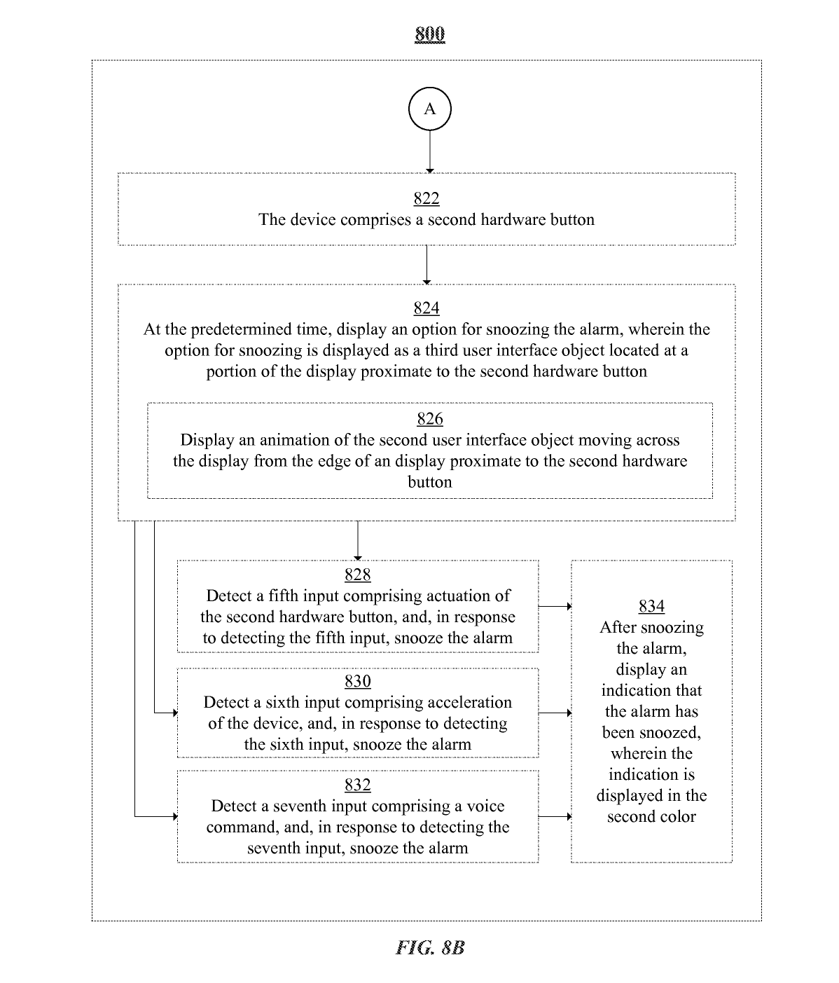

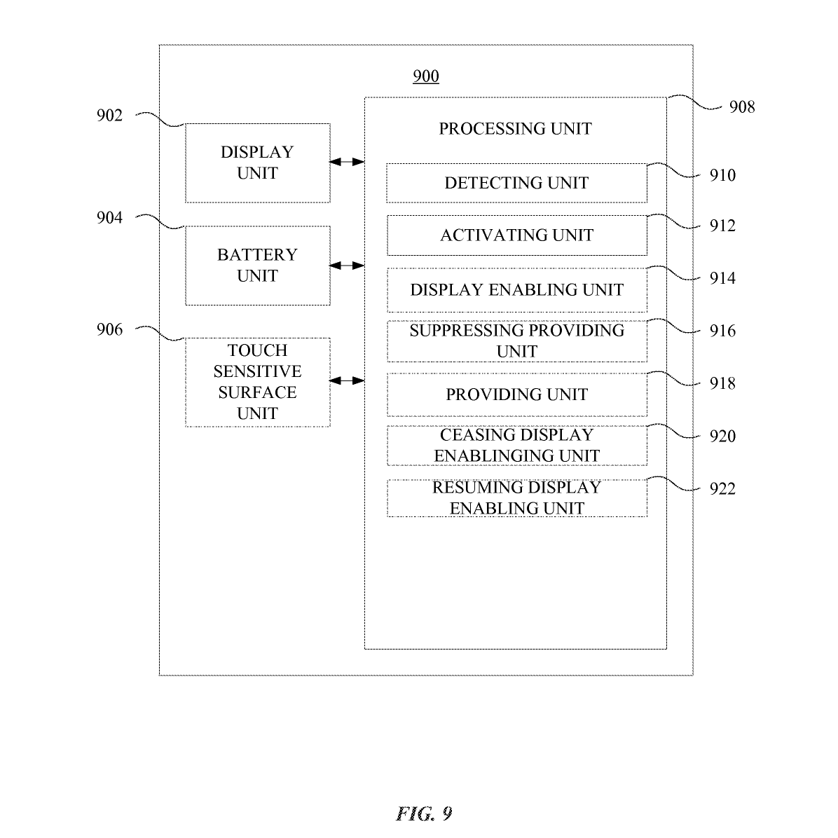

Below, FIGS. 1A-1B, 2, 3, 4A-4B, and 5A-5B provide a description of exemplary devices for performing techniques for providing, activating, and interacting with alarm clock interfaces, and for accessing and navigating user interfaces when a wearable device is not being worn by a user. FIGS. 6A and 6B illustrate a personal electronic device in accordance with some embodiments. FIGS. 6C-6M illustrate exemplary user interfaces in accordance with some embodiments. The user interfaces in the figures are also used to illustrate the processes described below, including the processes in FIGS. 7A-7C and 8A-8B.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes one or more computer-readable storage mediums. The computer-readable storage mediums are optionally tangible and non-transitory. The computer-readable storage mediums are optionally transitory. Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

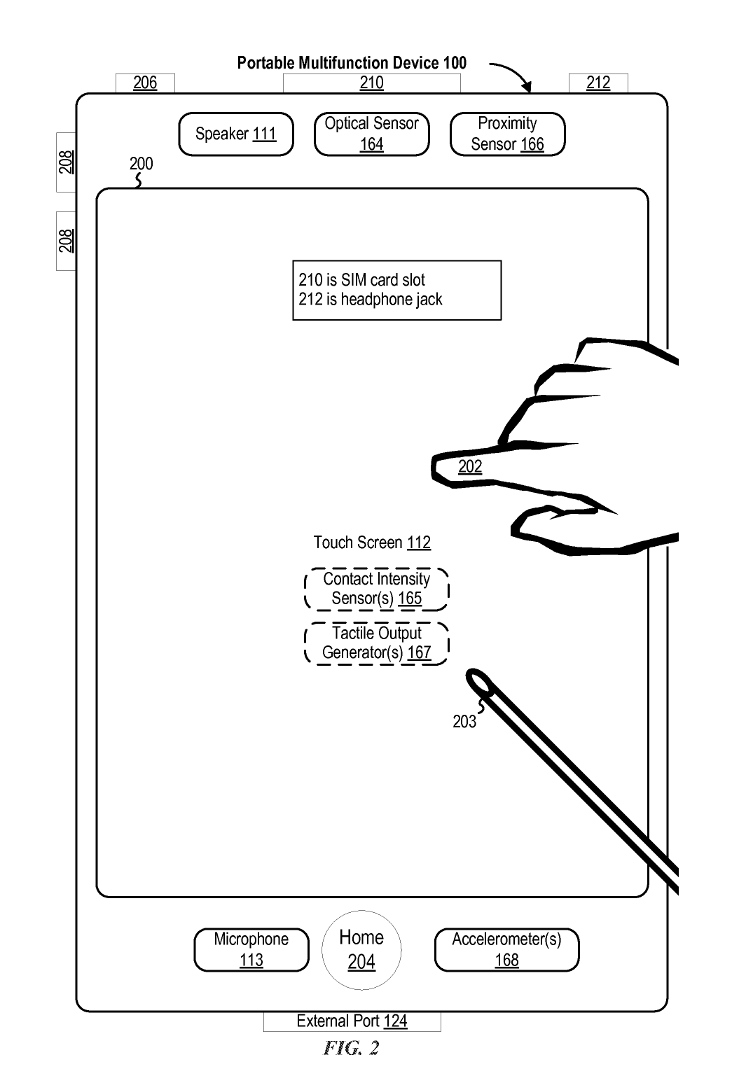

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

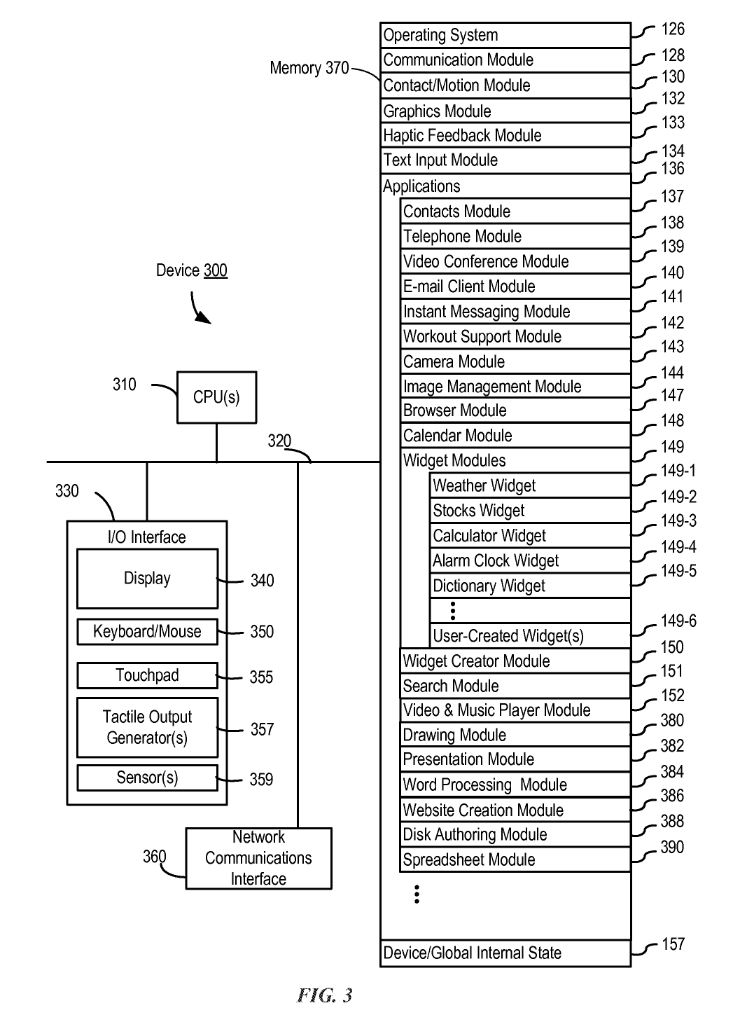

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 are, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that is, optionally, implemented on, for example, portable multifunction device 100.

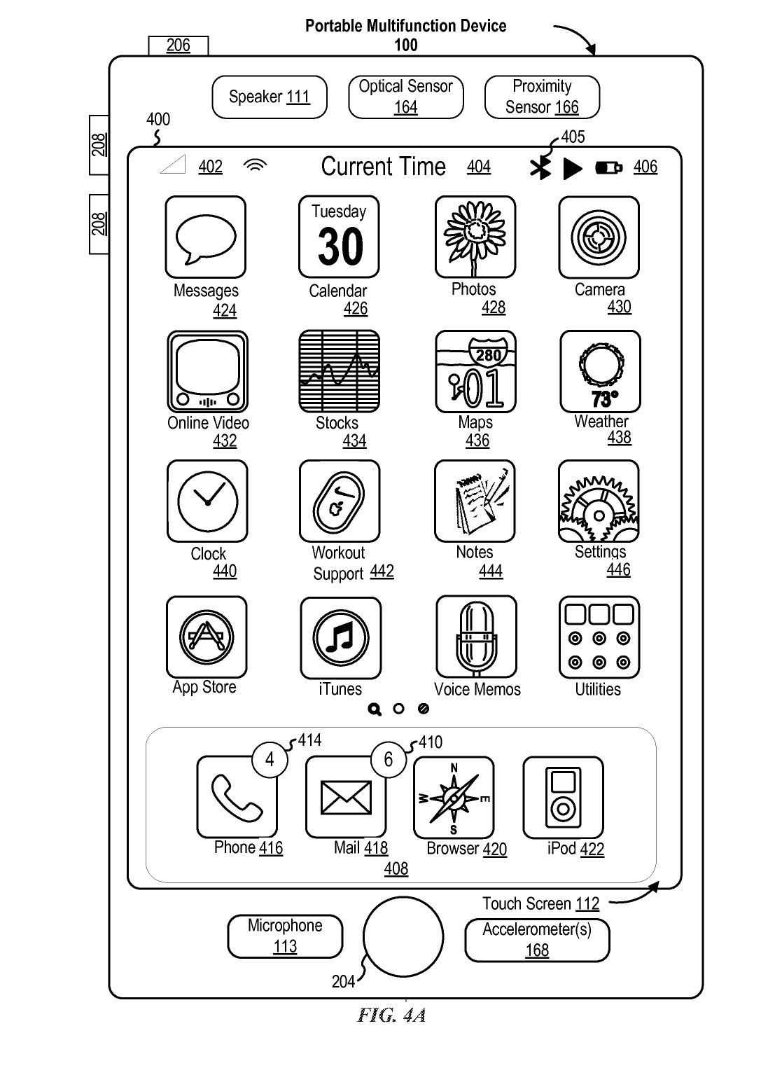

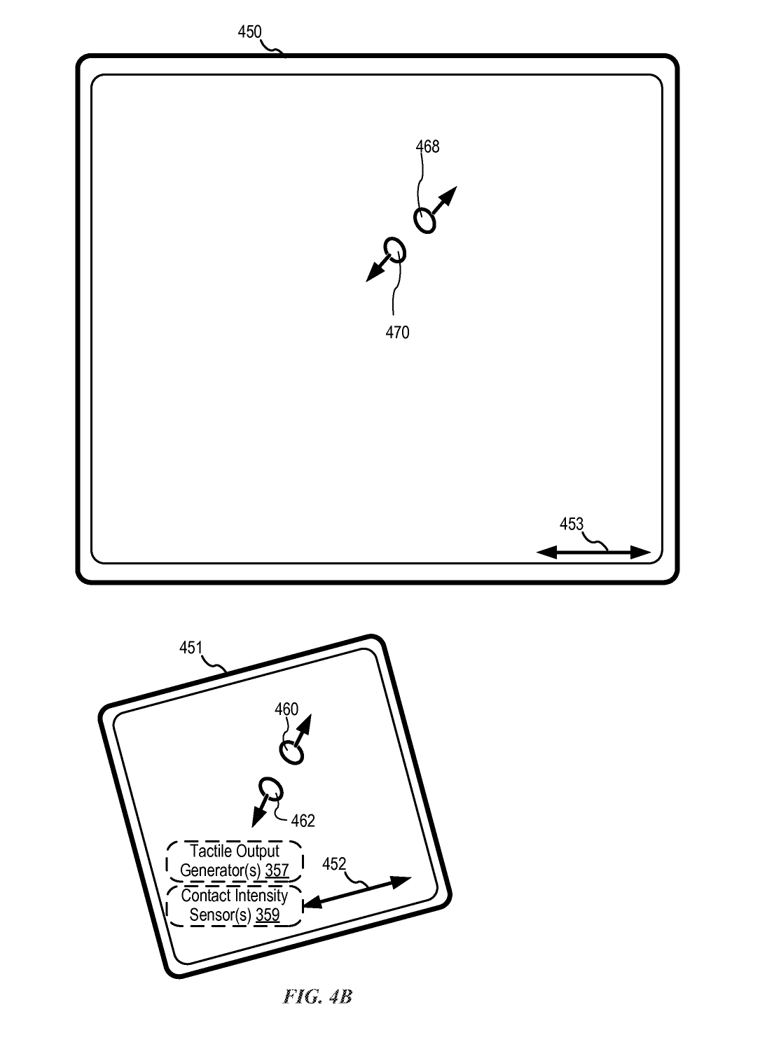

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples which follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

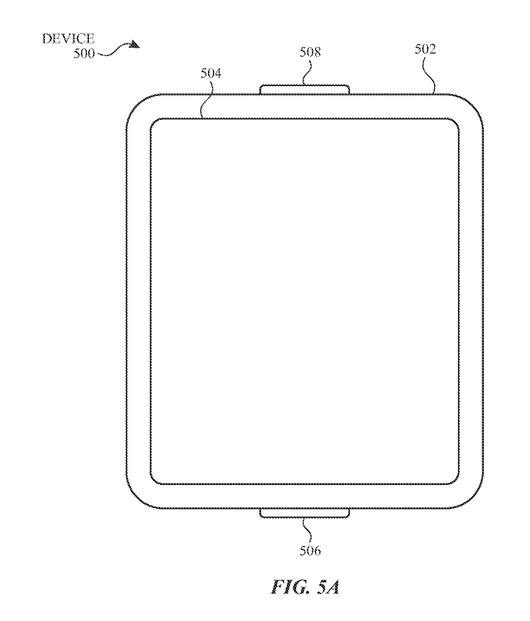

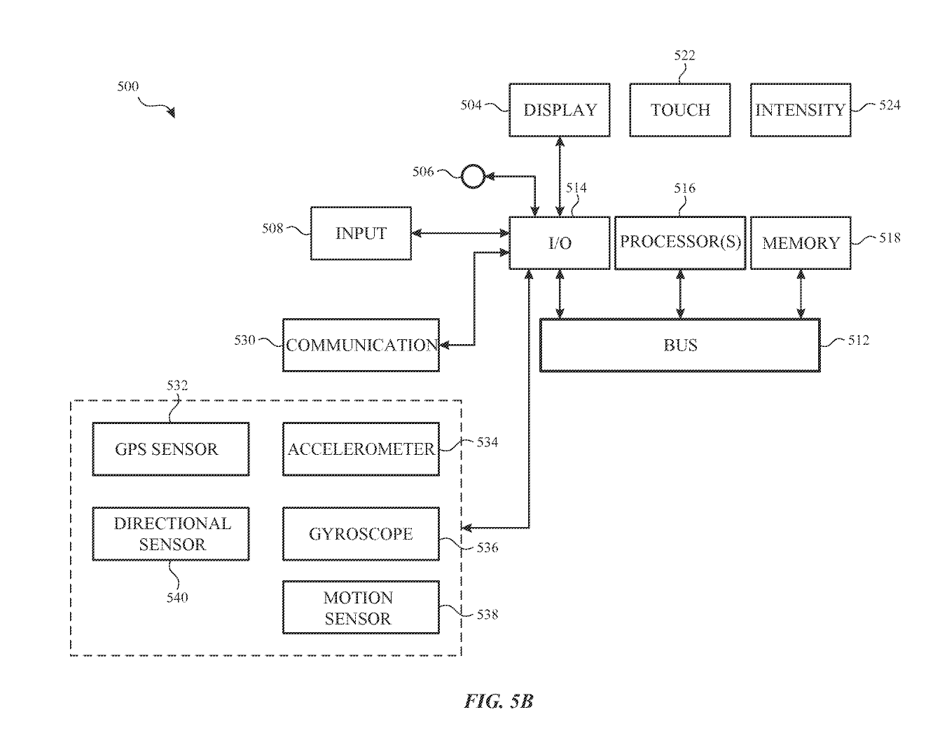

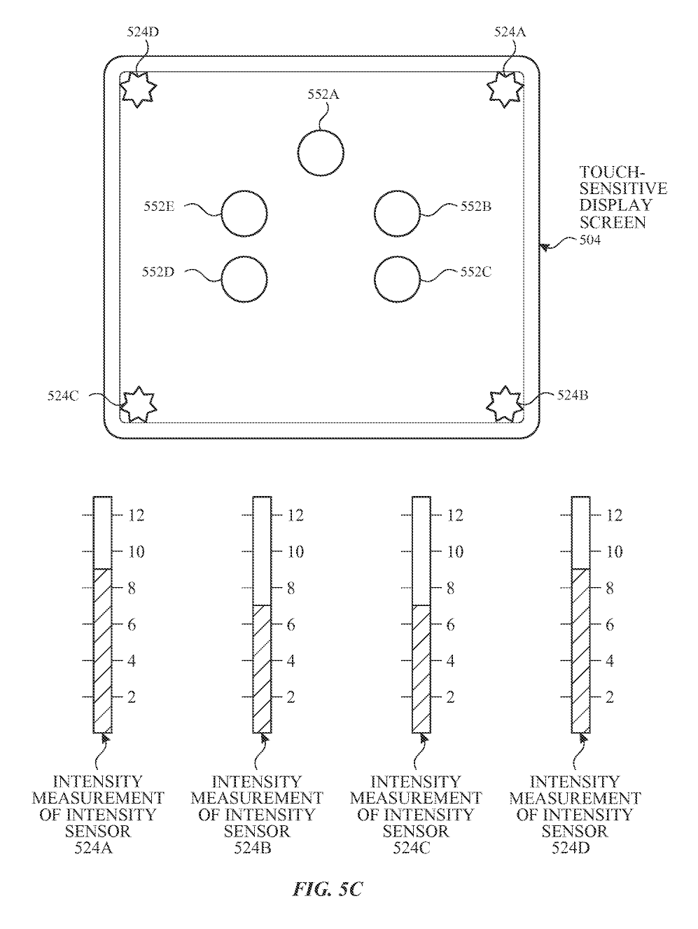

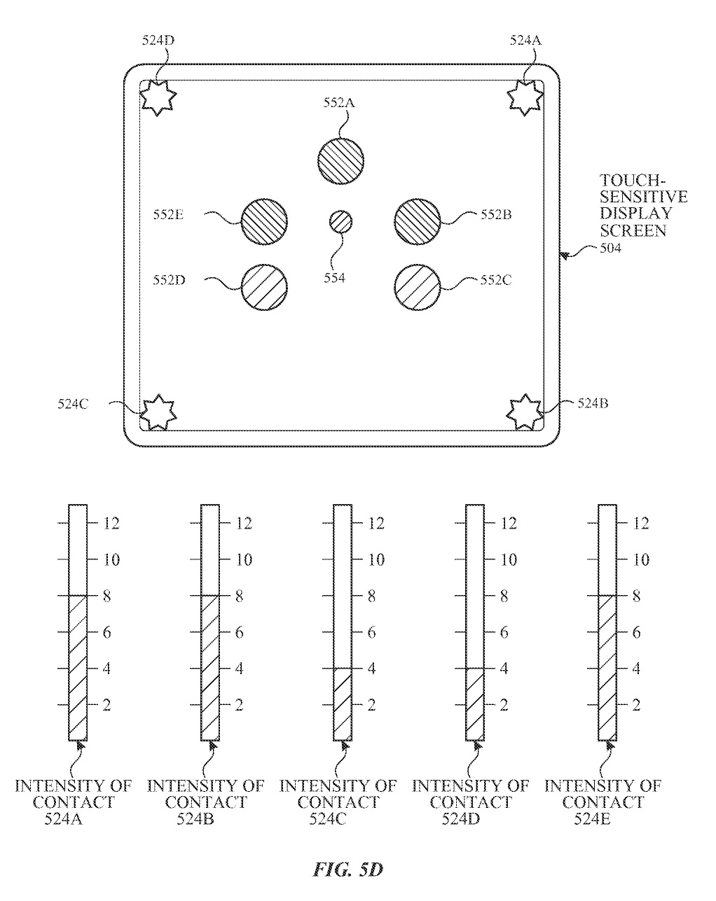

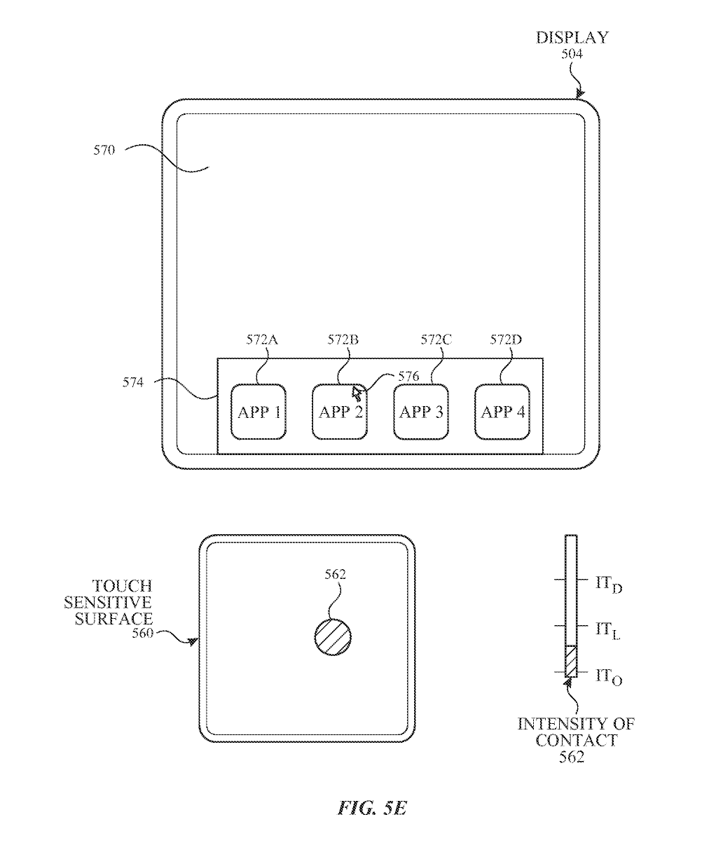

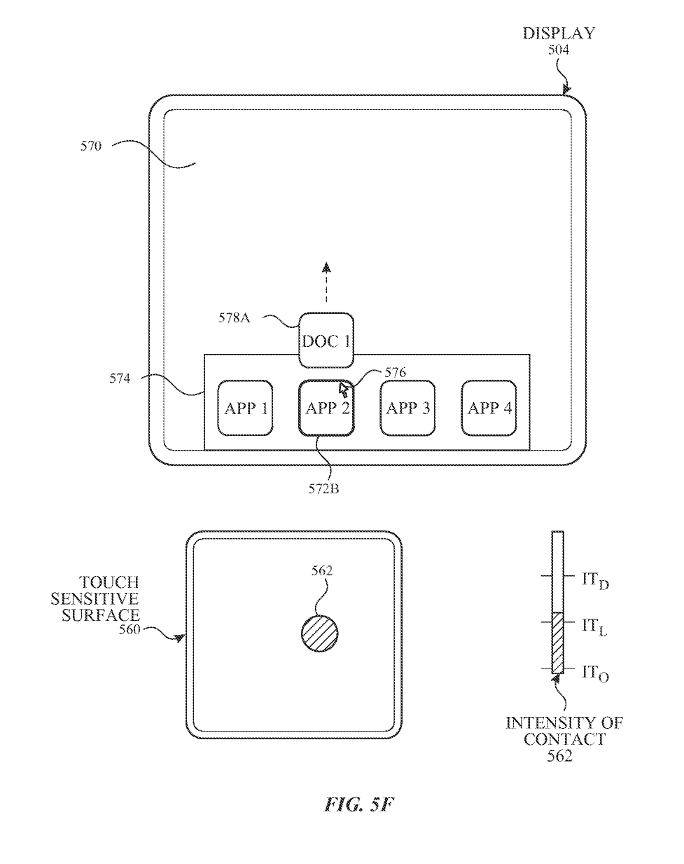

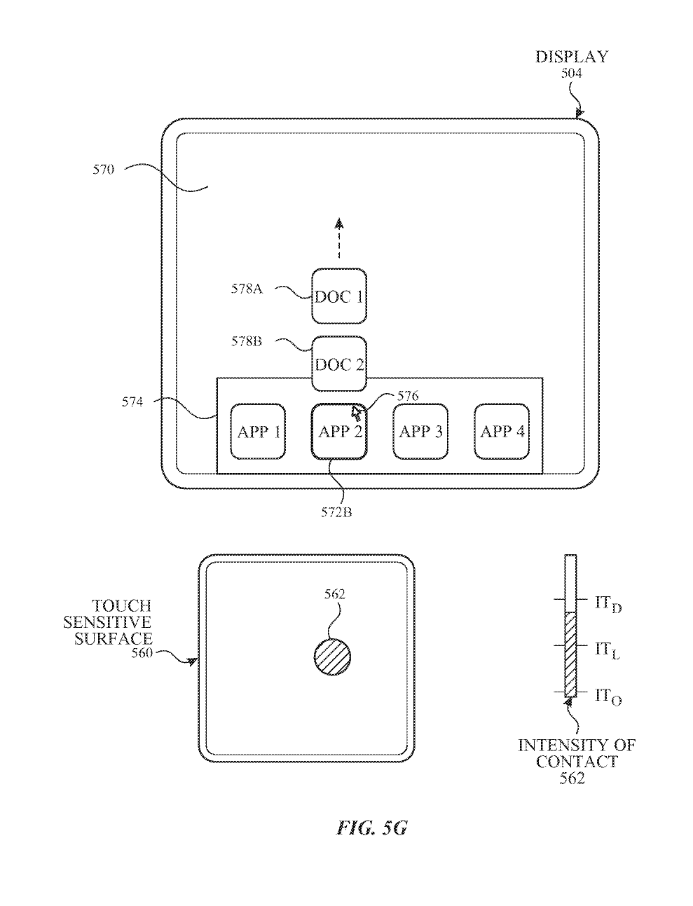

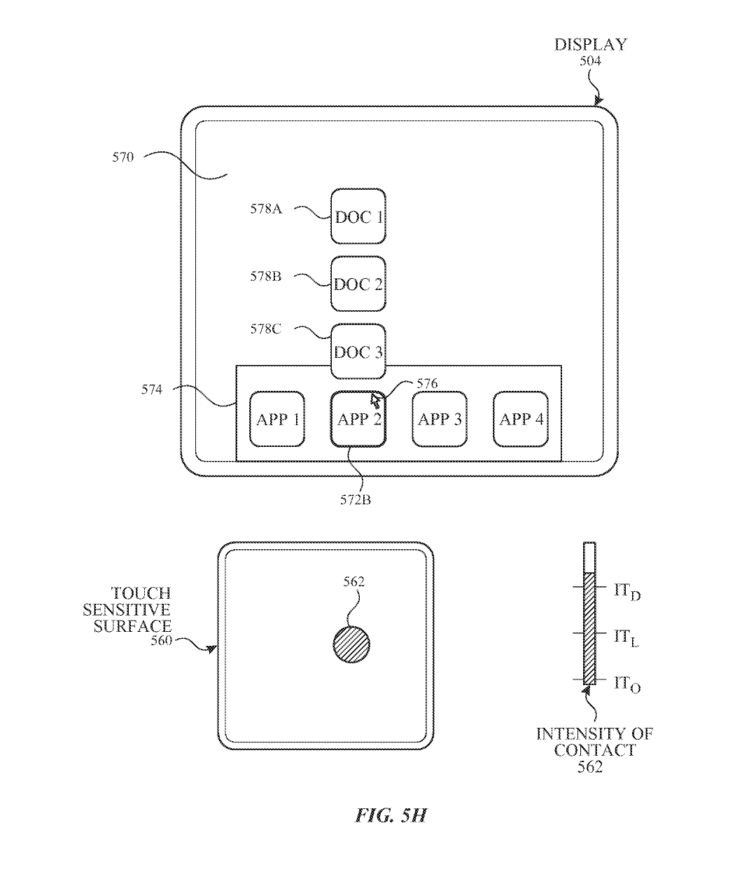

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can be a non-transitory computer-readable storage medium, for storing computer-executable instructions, which, when executed by one or more computer processors 516, for example, can cause the computer processors to perform the techniques described above, including processes 700 and 800 (FIGS. 7 and 8). The computer-executable instructions can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. For purposes of this document, a “non-transitory computer-readable storage medium” can be any medium that can tangibly contain or store computer-executable instructions for use by or in connection with the instruction execution system, apparatus, or device. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1, 3, and 5). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and EDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the term “open application” or “executing application” refers to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

FIGS. 6A and 6B illustrate an exemplary wearable electronic device in accordance with some embodiments. FIG. 6A depicts device 600, which in some embodiments includes some or all of the features described with respect to devices 100, 300, and/or 500. In some embodiments, device 600 has touch-sensitive and pressure-sensitive display 602 (sometimes simply called a touch-screen). In some embodiments, device 600 has rotatable and depressible input mechanism 604. In some embodiments, device 600 has depressible input mechanism 606. Display 602 and input mechanisms 604 and 606 can optionally share some or all characteristics, respectively, with display 504 and input mechanisms 506 and 508.

In some embodiments, device 600 includes an attachment mechanism for attaching, affixing, or connecting a device to a body part or to clothing of a user. In this manner, device 600 can optionally be considered a “wearable device,” sometimes simply referred to as a “wearable.” In the examples shown in FIGS. 6A and 6B, device 600 comprises wrist strap 608, which can optionally be used to affix the device to the wrist of a user. In the examples shown, device 600 takes the form factor of a “smart watch,” a portable electronic device configured to be affixed by strap 608 to the wrist of a user.

In some embodiments, device 600 includes charger 610 (as shown in FIG. 6B). In some embodiments, charger 610 can optionally be considered part of device 600, while in some embodiments charger 610 can optionally be considered to be an external element to which device 600 attaches or is otherwise in electrical communication or electromagnetic communication with. Charger 610 can optionally be any element capable of transmitting electricity (e.g., direct current or alternating current) from source of electricity to a charging interface of device 600 or to a battery of device 600, or can optionally be any element capable of creating an electromagnetic field configured to transfer energy (e.g., by inductive charging) to device 600 or to a battery of device 600. For example, charger 610 can optionally be any standard charging connector, such as a USB connector, a mini-USB connector, or a micro-USB connector. Charger 610 can optionally be a proprietary connector, including but not limited to an Apple Lightning connector. In the example shown in FIG. 6B, charger 610 is a puck-shaped charging connector that is magnetically attracted to a back face of device 600 and utilizes inductive charging to deliver a charge to the battery of device 600. In some other embodiments (not pictured), charger 610 can optionally be held in place to deliver electricity to device 600 by friction.

Both FIGS. 6A and 6B depict device 600 in a resting position, laid on its side on a surface. FIG. 6B clearly illustrates, by way of the horizontal line at the bottom of the figure, the surface upon which device 600 is resting. In the examples shown, strap 608 of device 600 props device 600 in a position such that display 602 faces substantially horizontally; that is, the primary plane of display 602 is substantially parallel with the direction of gravity. In the examples shown, input mechanisms 604 and 606 are facing substantially upwards from the surface upon which device 600 is resting. In some embodiments in which device 600 takes the form factor of a watch, device 600 can optionally rest in the depicted position when the device is set down on a tabletop surface, such as a nightstand.

Attention is now directed toward embodiments of user interfaces and associated processes that can optionally be implemented on an electronic device, such as device 100, 300, 500, or 600.

FIGS. 6C-6M illustrate exemplary user interfaces. FIGS. 7A-7C and 8A-8B are flow diagrams illustrating exemplary methods. The user interfaces in FIGS. 6C-6M are used to illustrate the processes in FIGS. 7A-7G and 8A-8B.

Attention is now directed toward techniques for activating and navigating a user interface. In some embodiments, the user interface is intended for use when a device is resting on a nightstand, such as beside a user's bed. In some embodiments, the user interface can optionally be referred to as a “nightstand interface,” “nightstand mode,” “alarm clock interface,” “alarm clock mode,” “desk clock interface,” or “desk clock mode.” The user interface and associated modes of operation can optionally, in some embodiments, include an alarm clock feature, a nap timer feature, a time display feature, a battery-charge-level display feature, one or more notification display features (including notification summary features), and one or more status-indicator display features. For example, nightstand mode can optionally, in some embodiments, cause the display of a clock face (e.g., a displayed likeness of a digital or analog time indicator) and the activation of an alarm clock, and can optionally cause the display of notification summaries when the device is awakened during nightstand mode (e.g., in the middle of the night) or upon the dismissal of an alarm (e.g., first thing in the morning).

In some embodiments, nightstand mode and its associated user interfaces can optionally be activated in response to contextual factors detected by the device. This can optionally be in contrast to, or in addition to, traditional mode/interface activation triggers such as explicit user input. For example, in some embodiments, nightstand mode can optionally be activated automatically when a device detects that it has been placed in a certain location or a certain orientation, and/or when the device detects that it is being charged, and/or when it is a predetermined time of day. For example, a device can optionally detect that it has been laid on a surface in a predetermined orientation, and that it has been connected to a battery charger, and it can optionally automatically responsively activate nightstand mode. In some embodiments, nightstand mode can optionally be automatically deactivated when the device is moved from the predetermined location or orientation or when it is disconnected from a battery charger.

FIG. 6C depicts exemplary user interface 613 of device 600 (strap 608 is not pictured), displayed on display 602. User interface 613, in some embodiments, is a user interface of a nightstand mode of device 600. In some embodiments, user interface 613 can optionally be automatically displayed when device 600 detects that it is oriented in a predefined orientation and that its battery is being charged. For example, device 600 can optionally detect that it is oriented in the manner depicted in FIGS. 6A and 6B, laid on its side in a substantially horizontal position with charger 610 attached to the back face of the device, and device 600 can optionally responsively display interface 613.

User interface 613 includes alarm indicator 614, which is an icon in the shape of an alarm clock that indicates that an alarm is activated. User interface 613 includes charging indicator 616, which is an icon in the shape of a lightning bolt accompanied by a numeric indication of the percentage change of the battery (in the displayed example, 83%). User interface 613 further includes time indicator 618, which is an indication of a current time. In some embodiments, time indicator 618 can optionally occupy a substantial portion of display 602, such as more than 10%, more than 20%, more than 30%, more than 40%, more than 50%, or more than 75% of the area of display 602. This may be advantageous because display 602 can optionally be small (e.g., less than 3 inches, 2 inches, or 1 inch in one or more dimensions) in some embodiments, and a primary purpose of a nightstand user interface can optionally be to display an easily readable indication of the current time that a user can view at a quick glance. Displaying the time in a sufficiently large size to be easily read on a small display may improve convenience, ease, and efficiency of use when a user tries to read a time in a darkened environment and when the user may be tired or groggy.

User interface 613 further includes date indicator 620, which indicates the day of the week and the day of the month. (In some other embodiments, date indicator 620 can optionally also indicate the month and/or year.)

User interface 613 further includes alarm time indicator 622, which indicates a time for which an alarm is set. In the example shown, the alarm time indicator indicates that an alarm is set by displaying the word “ALARM” and indicates that the alarm is set for 7:30 a.m. by displaying the text “7:30 AM.” In some embodiments, the alarm time indicator can optionally be displayed in a predetermined color. In some embodiments, the predetermined color is a color in which other elements on the interface (such as text or icons) are displayed. In some embodiments, the predetermined color is green. The predetermined color can optionally be selected to have a predetermined brightness, intensity, and hue, and these values can optionally be selected such that the interface is not overly bright or overly intense for a user to comfortably view in a darkened room in the middle of the night.

FIG. 6D depicts exemplary user interface 615, which is identical to exemplary user interface 613 except for the additional inclusion of do-not-disturb status indicator 624, which is an icon in the shape of a crescent moon. In some embodiments, a do-not-disturb indicator can optionally be displayed as part of a nightstand mode interface when device 600 has activated a do-not-disturb status. Activation of a do-not-disturb status can optionally cause incoming messages and notifications to be treated differently by device 600 (such as by suppressing pop-up notifications or auditory or haptic alerts). Activation of a do-not-disturb status can optionally also cause device 600 to transmit an indication of the do-not-disturb status to other devices or to third parties, such as by setting a visible/public status on a messaging application by which other parties can see that the device 600 is in do-not-disturb mode. In some embodiments, do-not-disturb mode can optionally be activated or deactivated manually by a user, and do-not-disturb status indicator 624 can optionally reflect whether or not such a mode is activated when a nightstand user interface is displayed. In some embodiments, do-not-disturb mode can optionally be automatically activated whenever nightstand mode is activated; for example, the same factors that cause interface 615 to be displayed can optionally also cause a do-not-disturb status to be activated. In some embodiments, this automatic activation can optionally be manually enabled or disabled by a user.

FIG. 6E depicts exemplary user interface 617, which is identical to exemplary user interface 613 except for the additional inclusion of notification indicator 626, which is an icon in the shape of a circle. In some embodiments, a notification indicator can optionally be displayed as part of a nightstand interface to visually indicate that a notification has been received by device 600; notifications can optionally pertain to received emails, received messages, calendar events, or any other communication or information about which device 600 can optionally inform the user. In some embodiments, notification indicators can optionally be displayed in a nightstand interface in lieu of alternate visual, auditory, or haptic indicators that would be provided if the device was not in nightstand mode. For example, an incoming email can optionally normally cause device 600 to display an indication of the email, produce an auditory tone, and produce a haptic output (e.g., a vibration); when nightstand mode is activated, in some embodiments, those results can optionally be suppressed, and a visual notification indicator, such as notification indicator 626, can optionally be provided instead. This may be advantageous because an indicator such as visual indicator 626 may not wake or disturb a user who is sleeping, while it can optionally still provide a passive indication that a notification has been received if the user wishes to explore the issue further.

In some embodiments, notification indicator 626 can optionally be provided only if a notification is received while device 600 is in do-not-disturb mode; notification indicator 626 can optionally then be provided in place of do-not-disturb indicator 624, adjacent to do-not-disturb indicator 624, or at the same location as do-not-disturb indicator 624, with each icon being cyclically displayed for a predetermined period of time. In some other embodiments, notification indicator 626 can optionally be displayed when a notification is received, whether or not device 600 is in do-not-disturb mode.

In some embodiments, notification indicator 626 can optionally be a selectable affordance, such that detection by device 600 of a touch contact at a location corresponding to notification indicator 626 can optionally cause the display of a user interface associated with a received notification.

FIG. 6F depicts exemplary user interface 619, which is a notification summary user interface. In some embodiments, a notification summary user interface is included as part of a nightstand mode or a nightstand user interface, and can optionally display information about notifications received while a device has been in nightstand mode. Interface 619 includes notification indicator 630 and notification indicator 632, which indicate one missed message and three new emails, respectively. The messages and emails associated with these notification indicators 630 and 632 can optionally have been received while device 600 was in nightstand mode.

In some embodiments, a notification summary can optionally be displayed when the device is in nightstand mode and the device receives an input corresponding to an instruction to display a notification summary. In some embodiments, device 600 can optionally cease to display an interface after a predetermined amount of time when the device is in nightstand mode; that is, the display 602 can optionally time out. In some embodiments, the predetermined time-out time can optionally be different (e.g., shorter or longer) when device 600 is in nightstand mode as compared to when device 600 is not in nightstand mode. When display 602 is timed out, in some embodiments, certain user inputs can optionally cause device 600 to be reawakened. In some embodiments, certain user inputs can optionally cause device 600 to display a nightstand interface such as interface 613, 615, or 617, while certain user inputs can optionally cause device 600 to display a notification interface such as interface 619. In some embodiments, for example, a tap or series of taps can optionally be detected by an accelerometer of device 600. In response to an accelerometer detecting a single tap, device 600 can optionally display a nightstand interface such as interface 613, 615, or 617; while in response to an accelerometer detecting a double-tap (e.g., two taps detected in succession within a predetermined period of time, such as one second), device 600 can optionally display a notification interface such as interface 619. In some embodiments, notification interface 619 can optionally be displayed in response to any other suitable user input, such as a touch contact detected at a location corresponding to notification indicator 626 in FIG. 6E, an actuation of a hardware button, or a voice command.

In some embodiments, notification indicators 630 and 632 can optionally be selectable affordances. For example, in response to a touch contact detected at a location corresponding to one of the notification indicators 630 or 632, an interface corresponding to the associated messages or emails can optionally be displayed.

FIGS. 6G and 6H depict exemplary user interfaces 621 and 623, respectively, which are user interfaces that can optionally be displayed when an alarm goes off. In some embodiments, when an alarm that is set on device 600 goes off (e.g., the current time reaches the predetermined time of the alarm), device 600 can optionally emit or provide an auditory alarm tone, and one or more user interface objects can optionally cease to be displayed on display 602, begin to be displayed on display 602, or change appearance in their display on display 602. In some embodiments, a user interface object can optionally change appearance when the alarm of the device goes off, such as by being highlighted or by changing color. For example, alarm time indicator 622 can optionally change color when the alarm goes off, such as by changing from green to orange. If display 602 is timed out when the alarm time is reached, then alarm time indicator 622 can optionally be displayed in a new color (e.g., orange) immediately upon reactivation of display 602 and display of interface 621.

In the example shown, interfaces 621 and 623 contain many of the same elements as interfaces 613, 615, and 617, which can optionally represent interfaces displayed before an alarm has gone off. When the current time changes from 7:29 to 7:30 a.m., the time displayed by time indicator 618 changes accordingly and the alarm set in interfaces 613, 615, and 617 goes off. Furthermore, in some embodiments, at the time when the alarm goes off, the elements displayed along the top edge of interfaces 613, 615, and 617 (e.g., alarm indicator 614, charging indicator 616, etc.) can optionally cease to be displayed (or not be displayed upon the reawakening of display 602); instead, dismissal object 634 and snoozing object 636 can optionally be displayed, as depicted in FIGS. 6G and 6H. FIGS. 6G and 6H together depict how dismissal object 634 and snoozing object 636 are displayed on display 602 as moving/translating in a downward direction from the top edge of display 602 toward the bottom of display 602; this animation can optionally cause the objects to appear as if they are sliding onto the screen from off the edge.

In the example shown, dismissal object 634 is displayed at a location on display 602 that is adjacent to rotatable input mechanism 604, and snoozing object 636 is displayed at a location on display 602 that is adjacent to depressible input mechanism 606. The dismissal and snoozing objects can optionally respectively represent options for dismissing and snoozing the alarm that is going off. In some embodiments (not depicted), the dismissal option and snoozing option can optionally appear in opposite positions and can optionally be associated with the opposite hardware mechanisms as in the embodiments depicted herein. In some embodiments, the snoozing option and/or dismissal option can optionally be associated with and/or displayed adjacent to any suitable hardware button.

Dismissal object 634 can optionally be said to be associated with rotatable input mechanism 604 due to its proximity to rotatable input mechanism 604, and snoozing object 636 can optionally be said to be associated with depressible input mechanism 606 due to its proximity to depressible input mechanism 606. In some embodiments, depression and/or rotation of rotatable input mechanism 604 can optionally cause device 600 to dismiss the alarm, causing the alarm tone to cease to sound. In some embodiments, upon dismissing an alarm, alarm indicators such as alarm indicator 614 or alarm time indicator 622 can optionally cease to be displayed. In some embodiments, upon dismissing an alarm, one or more user interface objects can optionally change appearance, including by changing color; for example, alarm time indicator 622 can optionally change from orange (its color when an alarm is sounding) back to green (its previous color). In some embodiments, upon dismissing an alarm, another user interface screen altogether can optionally be displayed.

FIG. 6H depicts user inputs 638a, 638b, and 638c, all of which represent user inputs detected by device 600. Input 638a represents an actuation input (e.g., one or more depressions and/or rotations) applied to rotatable input mechanism 604. Any of these three inputs (or any other input configured to dismiss the sounding alarm) can optionally cause device 600 to dismiss the sounding alarm.

In some embodiments, input 638a is a single press of rotatable input mechanism 604. A downward press of rotatable input mechanism 604 may be easy, convenient, effective, and efficient for a user to apply because device 600 can optionally be configured to display interface 623 and accept input 638a when device 600 is resting in a position such as the position depicted in FIGS. 6A and 6B. Thus, when device 600 is resting on a surface such as a nightstand (as opposed to being attached to a user's wrist), an attempt to apply a touch input to display 602 may be difficult because it may cause device 600 to be accidentally moved across the nightstand by the force of the user's touch. Similarly, if a user attempts to apply a rotational input to rotatable input mechanism 604, device 600 may spin on the nightstand under the force of the user's rotational input. Thus, when device 600 is not anchored to any object of sufficient weight to prevent the object from being accidentally moved by a user's inputs, a downward press of rotatable input mechanism 604 may be advantageous because it will not cause device 600 to be accidentally moved or spun about.

In some embodiments, input 638b represents an acceleration input applied to device 600, such that an accelerometer of device 600 detects that the device has been accelerated. In some embodiments, input 638b is a tapping input, such as a tap or a series of taps detected by an accelerometer of device 600. The taps can optionally be applied to any part of device 600, to any device or accessory connected to device 600, or to any surface on which device 600 is resting. In some embodiments, device 600 can optionally be resting on a second device that is in electrical communication or electromagnetic communication with device 600, and the second device can optionally be larger than device 600 in one or more dimensions, such that a portion or surface of the second device can optionally be tapped by a user to transmit acceleration to device 600. In some embodiments, input 638b is a double-tap input (e.g., two taps detected in succession within a predefined period of time). A double-tap input may be an advantageous input for dismissing an alarm because, as discussed above, touch-contact inputs and rotational inputs may cause substantial undesired displacement of device 600 when it is resting on a nightstand. Conversely, a tap input activating an accelerometer of device 600 can optionally be delivered in any direction, or can optionally be a very light input, such that it does not cause substantial displacement of device 600. The tap or taps comprising input 638b can optionally even be delivered to a connected accessory of device 600, or to the nightstand on which device 600 is resting, further obviating the risk of substantially displacing device 600 by a forceful contact applied directly to the body of device 600.

A double-tap input may further be an advantageous input for dismissing an alarm because a double-tap input is less likely than a single-tap input to be accidentally executed. That is, a user merely reaching for or attempting to move device 600 may activate an accelerometer, but a user is less likely to move device 600 in such a way that its accelerometer registers a double-tap input when the user did not intend for it to do so.

In some embodiments, input 638c represents a touch contact detected by touch-sensitive display 602. Touch contact input 638b can optionally be a single-touch input, a multi-touch input, a single-tap input, and/or a multi-tap input detected by touch- and/or pressure-sensitive elements in display 602. In the displayed example, input 638c is a single-finger, single-tap input detected at a location on display 602 corresponding to displayed dismissal object 634.

FIG. 6I depicts exemplary user interface 625, which is a morning summary interface. In some embodiments, such a user interface screen can optionally be referred to as a notification summary or a morning digest. A morning summary interface can optionally include displayed information regarding notifications or communications received overnight as well as other useful information regarding the day ahead. For example, a morning summary interface can optionally include a summary or indication of messages received since the time that nightstand mode was activated or since the last time notifications were checked (such as at notification summary interface 619); a summary or indication of new emails received in the same time period; a summary or indication of events in a calendar for the current day; other calendar information; weather information (e.g., a forecast for the day); exercise information; stock market information (e.g., futures); or the like.

In the depicted example, morning summary interface 625 includes user interface object 642, which is a text object indicating that device 600 has received one missed message. Morning summary interface 625 further includes user interface object 644, which is a text object indicating that device 600 has received three new emails. Morning summary interface 625 further includes user interface object 646, which is a text object indicating that a calendar accessible to device 600 indicates that the user has two meetings today. Morning summary interface 625 further includes user interface object 648, which is a text object indicating a weather forecast for the coming day (a projected high temperature of 81° and a projected 0% chance of precipitation). In some embodiments, any one of the aforementioned user interface objects can optionally contain more or less detailed information about the respective subject matter, such as by including a brief indication of the subject or content of messages, emails, or calendar events.

In some embodiments, one or more of objects 642-648 can optionally be selectable by a user, such as by a touch contact detected on display 602 at a location corresponding to a respective object. When a user selects a respective object on the morning summary interface, additional information about the object can optionally be displayed, such as an expanded (e.g., drop-down, pop-up) menu or outline or a separate interface screen.

In some embodiments, a list, such as the bulleted list depicted in the example of FIG. 6I on a morning summary interface can optionally extend beyond the edge of display 602. In some such embodiments, a user can optionally scroll through the list, such as by executing a swipe gesture on display 602 or by rotating rotatable input mechanism 604.

In the depicted example, morning summary interface 625 includes a message wishing the user “Good Morning.” In some embodiments, this message can optionally be customized by a user, tailored to a user's name or other personal information, or varied contextually based on the information in the summary below. In some embodiments, this message can optionally wish the user “Happy Birthday” on the user's birthday or can optionally display holiday-themed messages on appropriate days (e.g., “Happy Thanksgiving” or “Merry Christmas”).

In some embodiments, a morning summary interface such as interface 625 can optionally be dismissed in response to detecting any predetermined user input. In some embodiments, interface 625 can optionally be dismissed after time-out of display 602, detection of a tap input by an accelerometer of device 600, detection of a touch input detected by device 600, or detection of actuation of a hardware input mechanism (e.g., rotatable input mechanism 604 or depressible input mechanism 606) of device 600. In some embodiments, upon dismissal interface 625, a nightstand or desk clock interface such as interface 613 can optionally be displayed. In some embodiments, such as when device 600 is disconnected from charger 610 while interface 625 is being displayed, interface 625 can optionally be dismissed (e.g., cease to be displayed).

FIG. 6J depicts exemplary user interface 627 and depicts an alternate set of user inputs from those user inputs (638a-c) that were depicted in FIG. 6H. That is, user interface 627 is identical to user interface 623 depicted in FIG. 6H and can optionally depict the same moment in time at 7:30 a.m. when the alarm is going off. Unlike in FIG. 6H, in which user inputs 638a-c are depicted, in FIG. 6J, user inputs 650a-c are depicted. In some embodiments, user inputs 650a-c can optionally share some or all of the characteristics of user inputs 638a-c. In some embodiments, user inputs 650a-c can optionally differ from user inputs 638a-c in that user input 650a can optionally be a depression of depressible input mechanism 606 rather than a depression of rotatable input mechanism 604; user input 650b can optionally be a triple-tap input detected by an accelerometer rather than a double-tap input detected by an accelerometer; and user input 650c can optionally be a single-finger, single-tap input detected at a location on display 602 corresponding to displayed snoozing object 636. Any of these three inputs (or other input configured to snooze the sounding alarm) can optionally cause device 600 to snooze the sounding alarm.

In some embodiments (not shown), the snoozing option can optionally correspond to rotatable input mechanism 604 and can optionally be displayed on display 602 adjacent thereto. In some embodiments, such as those in which rotatable input mechanism 604 is associated with a snoozing option, rotating rotatable input mechanism 604 can optionally cause a sounding alarm to be snoozed. In some embodiments, rotating rotatable input mechanism 604 can optionally cause the snooze time for a sounding or snoozed alarm to be adjusted. For example, if the default snooze time for an alarm is nine minutes, a user can optionally snooze the alarm in some embodiments by depressing rotatable input mechanism 604. In some embodiment, when the user wishes to snooze for more or less than 9 minutes, he can optionally rotate rotatable input mechanism 604 in one direction to increase the snooze time to greater than nine minutes, and/or rotate rotatable input mechanism 604 in the opposite direction to decrease the snooze time to less than nine minutes. The rotation of rotatable input mechanism 604 to adjust a snooze time of an alarm can optionally occur, in some embodiments, with or without the previous depression of rotatable input mechanism 604.

FIG. 6K depicts exemplary user interface 629, which has many features in common with user interface 613 in FIG. 6C. FIG. 6K depicts a nightstand user interface that can optionally be displayed after snoozing an alarm. In some embodiments, device 600 can optionally display a nightstand interface or a desk clock interface after an alarm has been snoozed. Such an interface can optionally be displayed, for example, until display 602 times out after a predetermined amount of time has passed following the receipt of the snooze command. In some embodiments, user interface 629 can optionally differ from user interface 613 in that, rather than alarm time indicator 622, user interface 629 can optionally include snooze time indicator 660, which can optionally indicate that an alarm has been snoozed and the time for which it will remain snoozed. In the example shown, snooze time indicator 660 includes the text “Snoozing” and a countdown timer that currently displays “8:59” to indicate eight minutes and 59 seconds remaining until the alarm sounds again.

In some embodiments, snooze time indicator 660 can optionally be displayed in the same manner and style as alarm time indicator 622, such as being displayed in the same font, size, and color. In some embodiments, snooze time indicator 660 can optionally differ in one or more ways from the manner in which alarm time indicator 622 was displayed, such as by being displayed in a different size, style, font, or color. In some embodiments, snooze time indicator 660 can optionally be displayed in a green color or a gray color. The color in which snooze time indicator 660 is displayed can optionally be selected in order to be of a lower intensity or a lower brightness than alarm time indicator 622 is displayed when the alarm is sounding and the user is expected to wake up.

When snooze time indicator 660 reaches 0:00 and the snooze time expires, the alarm can optionally sound again in a similar manner as described above with respect to FIGS. 6G and 6H.

FIG. 6L displays exemplary user interface 631, which is an interface of a nightstand or desk clock interface in which a nap timer is set. In some embodiments, a nap timer can optionally be set instead of an alarm. A nap timer can optionally vary from an alarm in that it can optionally be used to time naps that are intended to last for a predetermined amount of time, such as 20 minutes, one hour, 90 minutes, etc., rather than being used to set an alarm for a predetermined time of day. In the depicted example, nap timer interface 631 differs from alarm interface 613 in FIG. 6C only in that time indicator 618 displays a different time (2:07 instead of 7:29), date indicator 620 displays a different day (Saturday the 14th rather than Tuesday the 10th), alarm indicator 614 is not displayed, battery charge indicator 616 indicates a different charge level (75% rather than 83%), and nap timer 662 is displayed in place of alarm time indicator 622. Nap timer 662 can optionally share some or all of the attributes of snooze time indicator 660 described above, except that, in some embodiments, nap timer 662 can optionally display the text “timer” rather than the text “snoozing.”

FIG. 6M depicts exemplary interface 633, which is a nightstand mode nap timer interface that can optionally be displayed, in some embodiments, when a nap timer has expired and an alarm is sounding. In some embodiments, when nap timer 662 reaches 0:00 and the nap time expires, an alarm can optionally sound in a similar manner as described above with respect to FIGS. 6G and 6H. In some embodiments, when nap timer 662 reaches 0:00 and the nap time expires, an alarm can optionally sound and an interface, such as interface 633, different from the interfaces described above with respect to FIGS. 6G and 6H, can optionally be displayed. Interface 633 includes user interface object 666, which comprises text reading “Timer Done” to indicate that the timer has expired. Interface 633 further includes user interface object 668, which is a dismissal option that can optionally be a selectable affordance. In some embodiments, interface object 668 can optionally be selected by a touch contact user input such as input 670, which can optionally be a single-finger, single-tap touch contact detected on display 602 at a location corresponding to a location at which object 668 is displayed. Detecting user input 670 can optionally cause device 600 to dismiss the sounding alarm. In other embodiments, any other suitable user input, including a voice command, can optionally be used to dismiss the alarm.

FIGS. 7A-7C are flow diagrams illustrating a method for activating a predefined mode of operation in accordance with some embodiments. Method 700 is performed at a device (e.g., 100, 300, 500, 600) with a display, a battery, and one or more processors. Some operations in method 700 can optionally be combined, the order of some operations can optionally be changed, and some operations can optionally be omitted.

As described below, method 700 provides an intuitive way to activate a predefined mode of operation. The method reduces the cognitive burden on a user for activating and interacting with alarm clock interfaces and for accessing and navigating user interfaces when a wearable device is not being worn by a user, thereby creating a more efficient human-machine interface. For battery-operated computing devices, enabling a user to access, configure, and navigate a screenreader mode faster and more efficiently conserves power and increases the time between battery charges (or shortens the time required for a battery to charge while a device is being used).

In FIG. 7A, at block 702, method 700 is performed at an electronic device having a display, a battery, and one or more processors. An exemplary device is device 600 of FIGS. 6A and 6B, which has display 602 and a battery that can optionally be charged by charger 610.

At block 704, the device detects that the battery is being charged. In some embodiments, a device can optionally detect that it is being charged by detecting electrical charge being delivered to a battery in the device. In some embodiments, a device can optionally detect that a battery is being charged by detecting electrical charge traveling over any predefined circuit in a device. In some embodiments, a device can optionally detect that a battery is being charged by detecting the presence of an electromagnetic field indicative of inductive charging. In some embodiments, a device can optionally detect that a battery is being charged by detecting that the total charge level of the battery is increasing, that it is not decreasing, or that it is decreasing at a rate that is slower than a rate that it would be decreasing if the battery were not being charged. In some embodiments, a device can optionally detect that it is being charged by detecting the physical presence of a charging connector or charger, such as by detecting that a plug is inserted. In some embodiments, a device can optionally detect that it is being charged in accordance with information transmitted over a data connection, such as receiving a signal over a USB or Apple Lightning connector that indicates that the device is connected to another electronic device (e.g., a computer) and is receiving a charge from the other device. In the example depicted in FIG. 6B, device 600 detects that a battery of device 600 is receiving a charge from charger 610.

At block 706, the device detects that the device is oriented in a predefined orientation (e.g., the orientation seen in FIG. 6B). In some embodiments, a device can optionally use one or more gyroscopes (e.g., gyroscope 536) to detect the orientation of the device. The one or more gyroscopes can optionally be arranged, oriented, and configured to detect the orientation of the device along different axes. In some embodiments, a device can optionally use a directional sensor such as a compass (e.g., directional sensor 540) to detect an orientation of the device. In some embodiments, a predefined orientation of the device can optionally be defined at least in part with respect to gravity. In some embodiments, a predefined orientation of the device can optionally be defined at least in part with respect to cardinal directions (e.g., north, south, east, or west). In some embodiments, a predefined orientation of the device can optionally be defined with respect to one or more axes of the device. In some embodiments, detecting that a device is oriented in a predefined orientation comprises detecting that the device is oriented within a range of orientations, such that a device need not be oriented in a precise orientation, but can optionally merely be placed in a position that is substantially near to the predefined orientation. For example, if a device is within 1°, 2°, 5°, 10°, 15°, 20°, or 30° of a predefined orientation, then the device can optionally detect that the device is substantially oriented in the predefined orientation.

At block 708, optionally, detecting that the device is oriented in a predefined orientation comprises detecting that a face of the display of the device is substantially vertical. In some embodiments, being substantially vertical comprises being within 1°, 2°, 5°, 10°, 15°, 20°, or 30° of a vertical orientation with respect to the direction of gravity. In the example depicted in FIGS. 6A and 6B, device 600 is resting on its side on a flat surface with the plane of display 602 oriented in a substantially vertical orientation. That is, the primary plane of display 602 is in a substantially vertical orientation, such that it is facing substantially sideways with respect to the surface upon which device 600 is resting.

In some embodiments, such an orientation may be advantageous for a nightstand mode or a desk clock mode because the display may be visible from across the room, or from a bed beside the nightstand; it may be easier to see the display from other locations in the room when the device is oriented with the display in a vertical orientation than it would be if the device were resting flat on its back face on a surface.

In the example depicted in FIGS. 6A and 6B, device 600 uses one or more gyroscopes (e.g., gyroscope 536) to detect that a face of display 602 of device 600 is substantially vertical.

At block 710, optionally, detecting that the device is oriented in a predefined orientation comprises detecting that a predefined face of the device is facing substantially upward. In some embodiments, a predefined face of the device can optionally be a face of the device other than the face on which a display is provided. In some embodiments, a predefined face of the device can optionally be a face of the device on which a display is provided. In some embodiments, a predefined face of the device can optionally be a face of the device on which one or more hardware buttons or other input mechanisms are provided.

In the example depicted in FIGS. 6A and 6B, the predefined face of the device is the face of the device on which rotatable input mechanism 604 and depressible input mechanism 606 are provided. When device 600 is placed in a resting position on a surface with rotatable input mechanism 604 and depressible input mechanism 606 facing upward or substantially upward (e.g., within 1°, 2°, 5°, 10°, 15°, 20°, or 30° of facing straight upward with respect to gravity), then one or more gyroscopes of device 600 (e.g., gyroscope 536) detect that the face of device 600 on which the input mechanisms are provided is facing substantially upward.

In some embodiments, such an orientation may be advantageous for a nightstand mode or a desk clock mode because, when device 600 is oriented with input mechanisms 604 and 606 facing upward, then input mechanisms 604 and 606 can optionally be depressed without the user inadvertently moving device 600. That is, the surface on which device 600 is resting provides a backstop to a user's presses on input mechanisms 604 and 606, so that device 600 can optionally be easily operated with one hand. This arrangement makes use of device 600 when it is not being worn by a user (e.g., strapped to a user's wrist) easier because it helps avoid inadvertent movement of device 600 and facilitates easier and more effective use with only one hand.

At block 712, optionally, in accordance with the detection that the battery is being charged and the detection that the device is oriented in the predefined orientation, the device activates a predefined mode of operation. In some embodiments, the predefined mode of operation can optionally be activated automatically in accordance with the detection that the device is in a predefined orientation and that the battery is being charged. This may increase convenience for the user by requiring fewer explicit inputs. In some embodiments, the mode of operation can optionally be activated in accordance with the aforementioned determinations and additionally in accordance with the detection of a user input, such as actuation of a button or contact with a touch-sensitive surface. In some embodiments, the mode of operation can optionally be activated in accordance with the detection of just one of (a) the battery being charged and (b) the device being oriented in a predefined orientation, while in some embodiments both are simultaneously required. In some embodiments, one or more additional determinations about a state or context of the device must additionally be made in order for the device to enter the predefined mode of operation, including, for example: determining that the device is located in a predefined geographic location; determining that it is a predefined time of day and/or day and/or date; determining that a calendar event is or is not ongoing; determining that physical environment is darkened; and/or determining that the device is or is not in motion (e.g., whether being accelerated as determined by an accelerometer).

In the example of FIG. 6C, device 600 determines that device 600 is being charged by charger 610 and that device 600 is in the predefined orientation with display 602 facing substantially horizontally and input mechanisms 604 and 606 facing substantially upward. In accordance with those determinations, nightstand mode is activated and interface 613 is displayed.

At block 714, optionally, activating a predefined mode of operation comprises activating a nightstand mode and displaying an interface of the nightstand mode. In some embodiments, a mode of operation can optionally refer to any predefined setting or series of settings that control the operation of an electronic device, including the activation or deactivation of hardware elements, the activation or deactivation of software elements such as operating systems or applications, or the alteration of one or more settings of software of the device. Just some examples of modes of operation can optionally include low-power or battery-saving mode, airplane mode (e.g., deactivation of hardware communication elements), silent mode, screen-reader mode (e.g., activation of blind or low-vision interface), do-not-disturb mode, and/or nightstand/desk-clock mode. In some embodiments, more than one mode can optionally be simultaneously active.

In some embodiments, a nightstand mode can optionally be a mode of operation that is configured to be used when the device is resting on a nightstand beside a user's bed. The nightstand mode of operation can optionally cause display of clock interfaces, alarm interfaces, and notification summary interfaces, and nightstand mode can optionally cause activation of a do-not-disturb mode. In the example depicted in FIG. 6C, the predefined mode of operation is a nightstand mode or a desk-clock mode, which in some embodiments causes display of a desk clock and alarm interface in a landscape orientation.

At block 716, optionally, activating a nightstand mode and displaying an interface of the nightstand mode comprises displaying a clock face. In some embodiments, a clock face is a likeness of an analog clock face with one or more of an hour hand, a minute hand, and a second hand. In some embodiments, a clock face is a digital clock display comprising a numerical indication of the time. In some embodiments, a clock face displayed in nightstand mode can optionally occupy more than 10%, more than 20%, more than 30%, more than 40%, more than 50%, or more than 75% of the area of a display. Displaying the time in a large size may be advantageous, because, in some embodiments, displaying the time can optionally be a core functionality of nightstand mode because users will desire to easily check the time by glancing at their devices when the devices are resting on nightstands. In some embodiments, a displayed clock face can optionally be a selectable affordance that can optionally cause the display of other user interfaces or the activation of other functions of the device if selected by a touch contact. In the depicted example in FIG. 6C, time indicator 618 is a clock face that is displayed as a part of interface 613.

At block 718, optionally, activating a nightstand mode and displaying an interface of the nightstand mode comprises displaying an alarm indicator. In some embodiments, an alarm indicator can optionally be any indication, such as a displayed user interface object, indicating whether an alarm is set and/or for when an alarm is set. A displayed alarm indicator can optionally be a textual representation or a graphical representation. In some embodiments, a displayed alarm indicator can optionally be a selectable affordance that can optionally cause the display of other user interfaces or the activation of other functions of the device if selected by a touch contact. In the depicted example in FIG. 6C, both alarm indicator 614 and alarm time indicator 622 are alarm indicators that are displayed as a part of interface 613. Alarm indicator 614 is a graphical representation that indicates that an alarm is set, and alarm time indicator 622 is a textual indicator that indicates both that an alarm is set and the time for which the alarm is set.

At block 720, optionally, activating a nightstand mode and displaying an interface of the nightstand mode comprises displaying a battery indicator. In some embodiments, a battery indicator can optionally be any indication, such as a displayed user interface object, indicating a state of a battery of the device, including whether the battery is being charged and/or a charge level of the battery. In some embodiments, a displayed battery indicator can optionally be a selectable affordance that can optionally cause the display of other user interfaces or the activation of other functions of the device if selected by a touch contact. In the depicted example in FIG. 6C, charging indicator 616 is a battery indicator that is displayed as part of user interface 613.

At block 722, optionally, activating a predefined mode of operation comprises activating a do-not-disturb mode. In some embodiments, a do-not-disturb mode can optionally be activated as part of (e.g., can optionally be included in) a nightstand mode. In some embodiments, activation of a do-not-disturb mode can optionally cause a change in a setting for one or more communications applications for the device and/or a change in a setting for one or more communication hardware interfaces for the device. In some embodiments, activation of a do-not-disturb mode can optionally cause incoming messages and notifications to be treated differently by the device, such as by suppressing pop-up notifications or auditory or haptic alerts and instead only displaying passive visual alerts. This may be advantageous because it may be less distracting to a user and less likely to cause the user to wake up due to an incoming notification. In some embodiments, activation of a do-not-disturb mode can optionally cause the device to transmit an indication of the do-not-disturb mode to other devices or to third parties, such as by setting a visible/public status on a messaging application by which other parties can see that the device is in do-not-disturb mode. In some embodiments, activation of a do-not-disturb mode can optionally cause the device to provide an indication that do-not-disturb mode has been activated, such as a displayed visual indicator. In the depicted example of FIG. 6D, upon detecting that device 600 is oriented in the predefined orientation and that the battery of device 600 is being charged, do-not-disturb mode is activated (e.g., along with nightstand mode) and do-not-disturb status indicator 624 is displayed to indicate that device 600 is in do-not-disturb mode.

In FIG. 7B, block 724 is optionally performed following blocks 712-722. At block 724, optionally, while nightstand mode is activated, in response to receipt of an incoming notification, the device suppresses providing a first notification indicator configured to be provided when nightstand mode is inactive and the device instead provides a second notification indicator. In some embodiments, when nightstand mode is inactive, the device is configured to provide a first kind of notification in response to an incoming message, email, application notification, or other form of communication. For example, when nightstand mode is inactive, the device can optionally display a pop-up notification, display a toast notification, display a full-screen notification, provide an auditory tone, and/or provide a haptic alert such as a vibration. However, when nightstand mode is active, a device can optionally suppress such notifications and refrain from providing them in response to an incoming communication; instead, the device can optionally provide a notification that is configured to be provided during nightstand mode. In some embodiments, the nightstand mode notifications are configured to be less obtrusive, less jarring, less loud, less bright, and the like; in this way, the notifications may be less likely to wake or disturb a user who is sleeping beside the charging device.

In some embodiments, a nightstand mode notification can optionally only be provided by the device upon the user manually reawakening the device, such that an incoming communication or notification is even less likely to disturb a sleeping user by awakening the display without his explicit command.

In the depicted example of FIG. 6E, device 600 has received an incoming message, email, application notification, or other form of communication, and rather than providing a notification of the style that would be provided when nightstand mode is inactive (e.g., pop-up, auditory tone, vibration, etc.), device 600 instead provides a notification by displaying notification indicator 624. In some embodiments, notification indicator 624 can optionally be small and displayed in a dim color or a color that is not intense, so as not to disturb a sleeping user.

Block 726 is optionally performed following blocks 712-722. At block 726, optionally, after a predefined period of time following the activation of the predefined mode of operation, the device ceases to display a user interface. In some embodiments, the user interface can optionally revert to a standard user interface of the device, such as a user interface that was displayed before activation of the mode of operation. In some embodiments, a display of the device can optionally time out after a predefined period of time, and the device can optionally cease to display the interface, cease to display any interface, or be powered off altogether.

In the example of nightstand/desk-clock modes, a display can optionally time out after a predefined period of time from the mode's activation, or after a predefined period of time of inactivity of the device (e.g., not receiving any user inputs). The display timing out after inactivity during nightstand mode can optionally cause the display to be less distracting to a user who is trying to sleep beside the charging device, as the screen could illuminate a dark room if it remained illuminated indefinitely. In some embodiments, deactivating a display during nightstand mode may help to prevent the display from being damaged by having an image “burn in” to the display after being displayed for too long. In some embodiments, the predefined period of time before which a user interface ceases to be displayed can optionally be different from a second predefined period of time that would be used if the device were not in the mode of operation. For example, a time-out time for a display of a device can optionally be shorter when the device is in nightstand mode than when the device is not in nightstand mode; this may be advantageous in some embodiments because a user may be less likely to want to extensively use the device when it is in nightstand mode, and may wish for the display to power down more quickly so that the user can quickly begin to fall asleep. In some embodiments, timing out more quickly while in nightstand mode can optionally facilitate faster charging of a battery (which can optionally be charging as a condition for the activation of nightstand mode).

At block 728, optionally, the device resumes display of the user interface at a predetermined time. In some embodiments, the predetermined time is a time for which an alarm or a nap timer is set to expire. The predetermined time can optionally be a time of day in some embodiments, or it can optionally be a time at which a countdown timer expires in some embodiments. In some embodiments, when the alarm time is reached, a nightstand/desk-clock interface is re-displayed after the display of the device was previously powered down following inactivity. In some embodiments, the interface that is displayed at the predetermined time is exactly the same as the interface that was previously displayed, while in some embodiments, one or more aspects of the interface that is displayed at the predetermined time is different from the interface that was previously displayed.

In the example depicted in FIGS. 6G and 6H, an alarm of device 600 is sounding because the predetermined time of day for the alarm to sound has been reached. If device 600 was previously asleep (e.g., display 602 powered down) from inactivity, then nightstand interfaces 621 and 623 would be displayed as display 602 is turned back on as the alarm sounds. In this example, interfaces 621 and 623 are similar but not identical to interface 613 in FIG. 6C, which can optionally have been displayed before display 602 of device 600 powered down. Interfaces 621 and 623, for example, reflect the updated time of day and show user interface objects 634 and 636 rather than alarm indicator 614 and charging indicator 616.

In the example depicted in FIG. 6M, an alarm of device 600 is sounding because a countdown nap timer (an interface of which is shown in FIG. 6L) has expired. If device 600 was previously asleep (e.g., display 602 powered down) from inactivity, then nightstand interface 633 would be displayed as display 602 is turned back on as the alarm sounds. In this example, interface 633 is substantially different from interface 631 in FIG. 6L, which can optionally have been displayed before display 602 of device 600 powered down.

Block 730 is optionally performed following block 726. At block 730, optionally, the device detects a first user input and, in response to detecting the first user input, resumes display of the user interface. In some embodiments, after a display of the device has timed out and a nightstand user interface screen has ceased to be displayed, a user can optionally execute a user input, and the device can optionally responsively resume display of a nightstand user interface screen. In some embodiments, the interface screen displayed on reawakening is identical to the interface screen displayed before the display was powered off, while in other embodiments the interface screen displayed upon reawakening has one or more differences from the interface screen displayed before the display was powered off.

The user input that causes a nightstand mode interface to be displayed again can optionally be any user input that is detected by the device, including actuation of a hardware button, contact with a touch- and/or pressure-sensitive surface, or a voice command. The user input can optionally also comprise movement or acceleration of the device, as detected by an accelerometer (e.g., accelerometer 534), a gyroscope (e.g., gyroscope 536), a directional sensor (e.g., directional sensor 540), a motion sensor (e.g., motion sensor 538), and/or a GPS sensor (e.g., GPS sensor 532). For example, the device can optionally detect that it has been lifted up and is no longer resting on a nightstand or other flat surface. In some embodiments, the user input can optionally comprise the connection or disconnection of one or more accessories, data connectors, or power connectors to the device. For example, the device can optionally detect that it has been disconnected from a charging connector (e.g., charger 610). In some embodiments, the user input can optionally comprise a voice command. In some embodiments in which the user input is delivered in the form of a touch contact, a press contact, or an acceleration of the device, the user input can optionally comprise one or more simultaneous and/or successive points of contact and/or one or more simultaneous and/or successive button actuations; for example, the device can optionally be configured to detect a short-press, a long-press, a single- or multi-finger single-press or multi-press (e.g., double-press with successive presses), or can optionally be configured to detect a single-tap acceleration or a multi-tap acceleration (e.g., double-tap with successive taps), or any combination thereof.

At block 732, optionally, the first user input comprises acceleration of the device. In some embodiments, acceleration of device 600 can optionally be detected by an accelerometer (e.g., accelerometer 534).

At block 734, optionally, the acceleration is transmitted to the device through a surface on which the device is resting. For example, acceleration detected by accelerometer 534 can optionally be detected after the acceleration is transmitted through a nightstand or other surface on which device 600 is resting. In this way, a user can optionally simply tap the surface on which device 600 is resting to effectuate an input, rather than having to precisely tap device 600 itself. This may be advantageous because, in some embodiments, a user of device 600 in nightstand mode in a darkened room may have difficulty precisely locating and tapping device 600, especially when display 602 is powered down.

At block 736, optionally, the first user input comprises one or more taps. In some embodiments, the one or more taps can optionally be detected by a touch-sensitive and/or pressure-sensitive surface. In some embodiments, the one or more taps can optionally be detected by an accelerometer. In some embodiments, the one or more taps can optionally constitute a single-tap input, a double-tap input, a triple-tap input, etc.

In some embodiments, a first set of one or more predefined user inputs can optionally cause reawakening of the device and display of a desk clock interface, such as interface 613 in FIG. 6C. For example, in some embodiments, when device 600 is in nightstand mode and the display has been powered down following inactivity, device 600 can optionally detect a user input comprising an acceleration of device 600. That is, device 600 can optionally detect, such as by accelerometer 534, that the device has been accelerated. Device 600 can optionally detect that it has been accelerated in a manner consistent with a single-tap acceleration. For example, a user can optionally tap the body of device 600, can optionally tap an accessory or charger to which device 600 is connected, or can optionally tap a surface (such as a nightstand) on which device 600 is resting. In response to detecting this single-tap acceleration user input, device 600 can optionally cause display 602 to be reactivated and can optionally cause a desk clock interface, such as interface 613, to be displayed. A user can optionally use such an input to reactivate the display of device 600 to check the time during the night.

In FIG. 7C, block 738 is optionally performed following blocks 712-722. In some other embodiments, block 738 is optionally performed following block 726 (e.g., following a display of a device powering down or going to sleep while in nightstand mode). At block 724, optionally, while nightstand mode is activated, the device detects a second user input and, in response to detecting the second user input, displays a user interface indicating a plurality of notifications.

In some embodiments, the second user input can optionally be any of the user inputs described above with reference to block 730, or can optionally be any other suitable user input. In some embodiments, as described above with reference to block 730, a first set of one or more predefined user inputs can optionally cause reawakening of the device and display of a desk clock interface, such as interface 613 in FIG. 6C. Further, in some embodiments, a second set of one or more predefined user inputs can optionally cause reawakening of the device and display of a different interface than a desk clock interface. For example, in some embodiments, a device can optionally display a notification summary interface upon reawakening, such as interface 619 in FIG. 6F. For example, in some embodiments while nightstand mode is activated, whether or not display 602 of device 600 is powered down, device 600 can optionally detect a second user input comprising an acceleration of device 600. That is, device 600 can optionally detect, such as by accelerometer 534, that the device has been accelerated. Device 600 can optionally detect that it has been accelerated in a manner consistent with a double-tap acceleration. For example, a user can optionally tap the body of device 600 twice in succession (e.g., two times within a predetermined period of time), can optionally double-tap an accessory or charger to which device 600 is connected, or can optionally double-tap a surface (such as a nightstand) on which device 600 is resting. In response to detecting this double-tap acceleration user input, device 600 can optionally cause a notification summary interface such as interface 619 in FIG. 6F to be displayed. A user can optionally use such an input to reactivate the display of device 600 to check notifications during the night, or to change from a desk clock interface to a notification summary interface to check notifications.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

Note that details of the processes described above with respect to method 700 (e.g., FIG. 7) are also applicable in an analogous manner to the methods described below with respect to method 800 (e.g., FIG. 8). For example, method 800 can optionally include one or more of the characteristics of method 700. For example, the devices, hardware elements, inputs, interfaces, modes of operation, and alarms described above with respect to method 700 can optionally share one or more of the characteristics of the devices, hardware elements, inputs, interfaces, modes of operation, and alarms described below with respect to method 800. Moreover, the techniques described below with respect to method 800 for displaying an option for dismissing an alarm can optionally be used while a device is in a mode of operation such as a nightstand mode, desk-clock mode, or alarm mode that can optionally be activated in accordance with the process described above with respect to method 700. For brevity, these details are not repeated below.

FIGS. 8A-8B are flow diagrams illustrating a method for displaying an option for dismissing an alarm in accordance with some embodiments. Method 800 is performed at a device (e.g., 100, 300, 500, 600) with a display, a hardware button, and one or more processors. Some operations in method 800 can optionally be combined, the order of some operations can optionally be changed, and some operations can optionally be omitted.

As described below, method 800 provides an intuitive way to display an option for dismissing an alarm. The method reduces the cognitive burden on a user for activating and interacting with alarm clock interfaces and for accessing and navigating user interfaces when a wearable device is not being worn by a user, thereby creating a more efficient human-machine interface. For battery-operated computing devices, enabling a user to access, configure, and navigate a screenreader mode faster and more efficiently conserves power and increases the time between battery charges (or shortens the time required for a battery to charge while a device is being used).

In FIG. 8A, at block 802, method 800 is performed at an electronic device having a display, a hardware button, and one or more processors. An exemplary device is device 600 of FIGS. 6A and 6B, which has display 602, rotatable input mechanism 604, and depressible input mechanism 606 (both input mechanisms being hardware buttons).

At block 804, the device displays a first user interface object in a first color. In some embodiments, the device has a display capable of displaying a user interface, and different elements of the user interface can optionally be displayed in different colors. In the depicted example, device 600 displays an alarm interface (sometimes alternately called a nightstand interface or a desk-clock interface), such as interface 613 of FIG. 6C. In some embodiments, device 600 displays alarm time indicator 622 in green. The text of alarm time indicator 622 can optionally be green because this color can optionally indicate to a user that the alarm has not yet gone off (e.g., that it is not yet 7:30 a.m.). In some embodiments, the text of alarm time indicator 622 can optionally be green because green is the color of other user interface objects in interface 613. In some embodiments, the text of alarm time indicator 622 can optionally be green because the color was selected such that its brightness, intensity, and hue are not overly bright, overly intense, or overly distracting for a user to comfortably display in a darkened room in the middle of the night.

At block 806, at a predetermined time, the device displays the first user interface object in a second color and displays an option for dismissing an alarm, wherein the option for dismissing is displayed as a second user interface object located at a portion of the display proximate to the hardware button. In some embodiments, the predetermined time is a time at which an alarm is predetermined to go off.

In the example depicted, in FIGS. 6G and 6H, an alarm goes off at 7:30 a.m. and causes the display of interface screens 621 and 623 successively. In some embodiments, if display 602 is powered down or asleep at the time of the alarm, then the display reawakens. In some embodiments, when the alarm has gone off or is going off, alarm time indicator 622 is displayed in orange. The text of alarm time indicator 622 can optionally be orange when the alarm is going off because this color can optionally indicate to a user that the alarm is now sounding. In some embodiments, the text of alarm time indicator 622 can optionally be orange when the alarm is going off because orange is not the color of other user interface objects in interface 613, such that orange may stand out and be more noticeable to a user who is awakening. In some embodiments, the text of alarm time indicator 622 can optionally be orange when the alarm is going off because the color was selected such that its brightness, intensity, and hue are brighter, more intense, or more attention-grabbing for a user who needs to wake up at the time of the alarm.

In some embodiments, such as when a countdown timer for timing a nap has reached zero, the second color can optionally be gray. An object can optionally be displayed in gray at the expiration of a nap timer in order to signal to a user that a nap timer, rather than a morning alarm, is currently going off.

As described above with reference to FIGS. 6G and 6H, interface screens 621 and 623 show how dismissal object 634 and snoozing object 636 can optionally be displayed on display 602 at the time the alarm goes off. In the depicted example, dismissal object 634 is an option for dismissing an alarm, displayed at a portion of the display proximate to a hardware button, as dismissal object 634 is displayed on display 602 at a position proximate to rotatable input mechanism 604. In some embodiments, dismissal object 634 indicates that a user can optionally press rotatable input mechanism 604 to dismiss the sounding alarm. (In some embodiments, dismissal object 634 can optionally also be a selectable affordance that can optionally be selected by a touch contact on display 602 at a location corresponding to dismissal object 634).

At block 808, optionally, displaying an option for dismissing an alarm comprises displaying an animation of the second user interface object moving across the display from an edge of the display proximate to the first hardware button. In some embodiments, the animation can optionally create the appearance that the second user interface object is appearing from behind the edge of the display from an off-screen area. In some embodiments, the second user interface object can optionally “bounce” back in the direction from whence it came when it reaches its final position, creating the illusion that the displayed object is a physical object subject to inertia and some form of elastic properties. In the depicted example in FIGS. 6G and 6H, dismissal object 634 is displayed as translating downward from the top edge of display 602 toward the bottom of display 602, reaching its final position in FIG. 6H.

Each of blocks 810-816 are optionally performed following blocks 806-810. Each of blocks 810-816 includes dismissal of an alarm. In some embodiments, blocks 810-816 are performed while the dismissing object is displayed. In some embodiments, dismissing an alarm comprises ceasing to provide a visual, auditory, and/or haptic indication that the alarm is going off. In some embodiments, dismissing an alarm comprises resetting the alarm for a next scheduled alarm time (e.g., the next day). Thus, in some embodiments, when a user's alarm is sounding in the morning, and the user intends to get up, a user dismisses the alarm to cause it to stop going off.

Each of blocks 810-816 includes detecting a user input. In some embodiments, an alternate user input can optionally be any of the user inputs described above with reference to block 730, or can optionally be any other suitable user input.

At block 810, optionally, the device detects a first input comprising actuation of the hardware button, and, in response to detecting the first input, dismisses the alarm. In some embodiments, alarm dismissal is performed in response to detection of an input comprising actuation of the hardware button. In some embodiments, the input comprises a single-press of the hardware button. In some embodiments, the input comprises multiple successive presses of the hardware button (e.g., a double-press or a triple-press detected within a predetermined amount of time). In some embodiments, the first comprises one or more long-presses of the hardware button (e.g., a press maintained for greater than a predetermined amount of time).

In the depicted example of FIG. 6H, device 600 detects input 638a, which is a single-press of rotatable input mechanism 604. As explained above with reference to FIG. 6H, a downward press of rotatable input mechanism 604 may be an advantageous form of input because, when device 600 is resting on a surface and not attached to a user's wrist, a downward press in the direction of the surface on which device 600 is resting may not cause device 600 to move about under the force of the user's input.

At block 812, optionally, the device detects a second input comprising acceleration of the device, and, in response to detecting the second input, dismisses the alarm. In some embodiments, alarm dismissal is performed in response to detection of an input comprising acceleration of the device. In some embodiments, the input comprises a single-tap of the device. In some embodiments, the input comprises multiple successive taps of the device. In some embodiments, the acceleration of the device is detected by an accelerometer of the device. In some embodiments, the acceleration of the device is caused by a user tapping the body of the device directly; in some embodiments, the acceleration of the device is caused by a user tapping an accessory or charger connected to the device; in some embodiments, the acceleration of the device is caused by a user tapping a surface on which the device is resting.

In the depicted example of FIG. 6H, device 600 detects input 638b, which is a double-tap of device 600. As explained above with reference to FIG. 6H, a double-tap of device 600 (or a connected accessory, or the surface on which device 600 is resting) may be an advantageous form of input because a user in a dark bedroom may be able to effectuate such an input without needing to precisely locate his input on any particular portion of his device; this may allow for faster and easier dismissing of an alarm. Furthermore, a double-tap input may be an advantageous input form because it may help to avoid inadvertent inputs; when an accelerometer is used to detect inputs, it may be easy for a user to inadvertently input a single-tap simply by trying to locate, move, or hold a device, but a double-tap input is less likely to be accidentally registered.

At block 814, optionally, the device detects a third input comprising a voice command, and, in response to detecting the third input, dismisses the alarm. In some embodiments, alarm dismissal is performed in response to detection of an input comprising a voice command. In some embodiments, the voice command can optionally be any predefined voice command in response to which the device is configured to perform dismissal.

In some embodiments, for example, a user can optionally speak any of the commands “Dismiss,” “Dismiss the alarm,” “Hey Siri, dismiss,” or “Hey Siri, dismiss the alarm,” and device 600 can optionally detect the voice command (e.g., by a microphone such as microphone 113 in FIG. 1A) and responsively dismiss an alarm. A voice command may be an advantageous input because, in some embodiments, it can optionally allow a user to dismiss an alarm without having to physically touch the device; the user can optionally accordingly control the device from outside arm's reach and with minimal physical effort and increased ease and quickness.

At block 816, optionally, the device detects a fourth input comprising a disconnection of the device from a charging connector, and, in response to detecting the fourth input, dismisses the alarm. In some embodiments, alarm dismissal is performed in response to detection of an input comprising disconnection of a device from a charging connector. In some embodiments, the device can optionally be disconnected from a charging connector while an alarm is currently sounding, and the disconnection can optionally cause the alarm to be dismissed and the sounding to cease.

In some embodiments, device 600 is disconnected from charger 610 (in FIG. 6B), and device 600 detects that it has been disconnected. In response to detecting the disconnection, device 600 dismisses the sounding alarm. Disconnection from a charging connector may be an advantageous input because, in some embodiments, it can optionally obviate the need of a user to enter an unnecessary input. For example, a user who disconnects device 600 from charging connector 610 has already woken up, so the alarm need not continue to sound; the user may find it convenient to not need to enter an explicit alarm dismissal command beyond simply disconnecting the device from a charging connector.

In some embodiments, in response to detecting disconnection of a device from a charging connector, a device can optionally cease to display a nightstand/desk-clock/alarm user interface. For example, when an alarm is dismissed, a device can optionally cease displaying an alarm interface and instead can optionally display a standard user interface of the device, such as a standard user interface configured for use when a wearable device is being worn by a user during the day.

In some embodiments, detection of a touch contact at a location corresponding to a displayed dismissal object can optionally cause dismissal of an alarm. For example, device 600 can optionally detect input 638c on display 602 in FIG. 6H and can optionally responsively dismiss the alarm.

Block 818 is optionally performed following any of blocks 810-816. At block 818, optionally, upon dismissing the alarm, the device displays a user interface indicating a plurality of notifications. In some embodiments, the user interface indicating a plurality of notifications can optionally be a summary user interface or a digest user interface. In some embodiments, the user interface can optionally indicate any pending notifications, while in some embodiments it can optionally indicate only those notifications that have been received while the device has been in nightstand mode, or only those notifications that have been received since a last time a user observed a notification interface. In some embodiments, a summary of notifications can optionally be presented in list form, and the list can optionally be categorized to group like notifications together or present like notifications as a single item. In some embodiments, the notification interface can optionally be scrollable, and it can optionally consist of one or more than one interface screens.

In the depicted example in FIG. 6I, after a user dismisses an alarm that is sounding (as shown in FIG. 6H), interface 625 is displayed. Interface 625 is a “Good Morning” digest interface that includes a bulleted list including notifications pertaining to missed messages (642), new emails (644), calendar events (646), and the weather (648). In some embodiments, interface 625 is displayed for a predetermined period of time. In some embodiments, interface 625 is pervasively displayed until device 600 receives an additional user input, such as an actuation of a hardware button, an acceleration of the device, a touch contact detected by a touch-sensitive surface, or a disconnection of the device from a battery charger.

At block 820, optionally, the device detects an eighth input comprising a disconnection of the device from a charging connector, and, in response to detecting the eighth input, ceases to display the user interface indicating the plurality of notifications. In some embodiments, the interface displaying a plurality of notifications can optionally cease to be displayed when the device detects a predetermined user input, such as an actuation of a hardware button, an acceleration of the device, a touch contact detected by a touch-sensitive surface, or a disconnection of the device from a battery charger. In some embodiments, the predetermined user input is the disconnection of the device from a charging connector or battery charger, and the user input causes the device to cease displaying a notification summary interface. In some embodiments, upon ceasing to display the notification summary interface, the device can optionally display another user interface, such as a nightstand interface screen or a standard user interface designed for use when a wearable device is being worn by a user during the day.

For example, in some embodiments, device 600 is displaying interface 625 in FIG. 6I. When a user is done reviewing the notifications presented by interface 625, the user disconnects device 600 from charger 610 (FIG. 6B), and device 600 responsively displays a user interface configured for use when device 600 is being worn on a user's wrist. This may be advantageous because, in some embodiments, a user who disconnects device 600 from charger 610 in the morning after an alarm has sounded may intend to pick up the device, and may no longer have any use for a nightstand or desk-clock interface.

Attention is now directed to FIG. 8B, in which block 822 optionally follows from blocks 806-808. At block 822, optionally, the device comprises a second hardware button. An exemplary device is device 600 of FIGS. 6A and 6B, which has rotatable input mechanism 604 (a first hardware button) and depressible input mechanism 606 (a second hardware button).

At block 824, optionally, at the predetermined time, the device displays an option for snoozing the alarm, wherein the option for snoozing is displayed as a third user interface object located at a portion of the display proximate to the second hardware button. In some embodiments, the predetermined time is a time at which an alarm is predetermined to go off. In some embodiments, when an alarm of the device goes off, an option to snooze the alarm is displayed simultaneously with the display, as explained above, of an option to dismiss the alarm. In some embodiments, snoozing an alarm causes alarm alerts (such as displayed alerts, auditory alerts, and/or haptic alerts) to be temporarily suppressed for a short time until the alarm then sounds again. For example, by snoozing an alarm, a user can optionally suppress the alarm for a predetermined amount of time, such as 5 minutes, 9 minutes, 10 minutes, or 15 minutes, and can optionally sleep in until the alarm goes off again at the later time.

As described above with reference to FIGS. 6G and 6H, interface screens 621 and 623 show how dismissal object 634 and snoozing object 636 can optionally be displayed on display 602 at the time the alarm goes off. In the depicted example, snoozing object 636 is an option for snoozing the alarm, displayed at a portion of the display proximate to the second hardware button, as snoozing object 636 is displayed on display 602 at a position proximate to depressible input mechanism 606. In some embodiments, snoozing object 636 indicates that a user can optionally press depressible input mechanism 606 to snooze the sounding alarm. (In some embodiments, snoozing object 636 can optionally also be a selectable affordance that can optionally be selected by a touch contact on display 602 at a location corresponding to dismissal object 634.)

At block 826, optionally, displaying an option for snoozing the alarm comprises displaying an animation of the third user interface object moving across the display from an edge of the display proximate to the second hardware button. In some embodiments, the animation can optionally create the appearance that the third user interface object is appearing from behind the edge of the display from an off-screen area. In some embodiments, the third user interface object can optionally “bounce” back in the direction from whence it came when it reaches its final position, creating the illusion that the displayed object is a physical object subject to inertia and some form of elastic properties. In the depicted example in FIGS. 6G and 6H, snoozing object 636 is displayed as translating downward from the top edge of display 602 toward the bottom of display 602, reaching its final position in FIG. 6H.

Each of blocks 828-832 are optionally performed following blocks 824-826. Each of blocks 828-832 includes snoozing of an alarm. In some embodiments, blocks 828-832 are performed while the dismissing object is displayed. In some embodiments, dismissing an alarm comprises ceasing to provide a visual, auditory, and/or haptic indication that the alarm is going off. In some embodiments, dismissing an alarm comprises resetting the alarm for a next scheduled alarm time (e.g., the next day). Thus, in some embodiments, when a user's alarm is sounding in the morning, and the user intends to get up, a user dismisses the alarm to cause it to stop going off.

Each of blocks 828-832 includes detecting a user input. In some embodiments, an alternate user input can optionally be any of the user inputs described above with reference to block 730, or can optionally be any other suitable user input.

At block 828, optionally, the device detects a fifth input comprising actuation of the hardware button, and, in response to detecting the fifth input, dismisses the alarm. In some embodiments, alarm snoozing is performed in response to detection of an input comprising actuation of the hardware button. In some embodiments, the input comprises a single-press of the hardware button. In some embodiments, the input comprises multiple successive presses of the hardware button (e.g., a double-press or a triple-press detected within a predetermined amount of time). In some embodiments, the input comprises one or more long-presses of the hardware button (e.g., a press maintained for greater than a predetermined amount of time).

In the depicted example of FIG. 6J, device 600 detects input 650a, which is a single-press of depressible input mechanism 606. As explained above with reference to FIG. 6H, a downward press of a hardware button disposed on the top face of a device that is resting on a surface may be an advantageous form of input because, when the device is resting on a surface and not attached to a user's wrist, a downward press in the direction of the surface on which device 600 is resting may not cause the device (e.g., device 600) to move about under the force of the user's input.

At block 830, optionally, the device detects a sixth input comprising acceleration of the device, and, in response to detecting the sixth input, snoozes the alarm. In some embodiments, alarm snoozing is performed in response to detection of an input comprising acceleration of the device. In some embodiments, the input comprises a single-tap of the device. In some embodiments, the input comprises multiple successive taps of the device. In some embodiments, the acceleration of the device is detected by an accelerometer of the device. In some embodiments, the acceleration of the device is caused by a user tapping the body of the device directly; in some embodiments, the acceleration of the device is caused by a user tapping an accessory or charger connected to the device; in some embodiments, the acceleration of the device is caused by a user tapping a surface on which the device is resting.

In the depicted example of FIG. 6J, device 600 detects input 650b, which is a triple-tap of device 600. As explained above with reference to FIG. 6J, multiple successive taps of device 600 (or a connected accessory, or the surface on which device 600 is resting) may be an advantageous form of input because a user in a dark bedroom may be able to effectuate such an input without needing to precisely locate his input; this may allow for faster and easier dismissing of an alarm. Furthermore, a triple-tap input may be an advantageous input form because it may help to avoid inadvertent inputs; when an accelerometer is used to detect inputs, it may be easy for a user to inadvertently input a single-tap simply by trying to locate, move, or hold a device, but a triple-tap input is less likely to be accidentally registered.

At block 832, optionally, the device detects a seventh input comprising a voice command, and, in response to detecting the seventh input, dismisses the alarm. In some embodiments, alarm dismissal is performed in response to detection of an input comprising a voice command. In some embodiments, the voice command can optionally be any predefined voice command in response to which the device is configured to perform dismissal.

In some embodiments, for example, a user can optionally speak any of the commands “Snooze,” “Snooze the alarm,” “Snooze the alarm for a half hour,” “Hey Siri, snooze,” “Hey Siri, snooze the alarm,” or “Hey Siri, snooze the alarm for half an hour,” and device 600 can optionally detect the voice command (e.g., by a microphone such as microphone 113 in FIG. 1A) and responsively snooze the alarm. A voice command may be an advantageous input because, in some embodiments, it may allow a user to snooze an alarm without having to physically touch the device; the user can optionally accordingly control the device from outside arm's reach and with minimal physical effort and increased ease and quickness.

In some embodiments, an alarm can optionally be snoozed for a predetermined period of time. In some embodiments, an alarm can optionally be snoozed for a period of time that is determined or selected in accordance with a user input. In some embodiments, for example, a user can optionally cycle through a predetermined set of snooze time options, each successive snooze time option being displayed in response to a further user input such as a further button press or device tap. In some embodiments, a snooze time can optionally be set in accordance with a characteristic of an input, such as the duration, force, or intensity of the input. In some embodiments, a snooze time can optionally be set or adjusted in response to a voice command.

In some embodiments, a snoozing option can optionally be associated with a rotatable input mechanism (rather than with a depressible input mechanism, as depicted in in FIG. 6J); in some such embodiments, a snooze time can optionally be set or adjusted in accordance with rotation of the rotatable input mechanism. In some embodiments, for example, a user can optionally depress a rotatable input mechanism to snooze an alarm, at which time the alarm will stop sounding and be set for a default snooze time (which can optionally be displayed). The user can optionally then rotate the rotatable input mechanism in either direction to respectively increase or decrease the snooze time (and the adjusted snooze time can optionally be displayed), in some embodiments.

In some embodiments, detection of a touch contact at a location corresponding to a displayed snoozing object can optionally cause snoozing of an alarm. For example, device 600 can optionally detect input 650c on display 602 in FIG. 6H, and can optionally responsively snooze the alarm.

At block 834, optionally, after snoozing the alarm, the device displays an indication that the alarm has been snoozed, wherein the indication is displayed in the second color. In some embodiments, the indication that the alarm has been snoozed can optionally be a textual and/or graphical user interface object that signals to the user that the alarm has been snoozed. In some embodiments, the indication that the alarm has been snoozed can optionally indicate the amount of time for which the alarm was snoozed and/or the amount of time for which the alarm will remain snoozed.

In the example depicted, in FIGS. 6J and 6K, an alarm goes off at 7:30 a.m. and causes the display of interface screen 627 in FIG. 6J. When a user input (e.g., any of inputs 650a-c) snoozes the alarm, interface 629 in FIG. 6K is displayed. In some embodiments, interface 629 is identical to interface 627, except that alarm time indicator 622 is replaced by snooze time indicator 660. In the depicted example, snooze time indicator 660 includes the text “SNOOZING” and includes a countdown timer showing the remaining time for which the alarm will remain snoozed. At the time interface 629 is depicted, there are eight minutes and 59 seconds remaining before the alarm sounds again. In some embodiments, when the alarm has gone off or is going off, snooze time indicator 660 is displayed in orange. The text of snooze time indicator 660 can optionally be orange because this color can optionally indicate to a user that the alarm has already sounded and been snoozed. In some embodiments, the text of snooze time indicator 660 can optionally be orange because orange is not the color of other user interface objects in interface 613, such that orange may stand out and be more noticeable to a user who is awakening. In some embodiments, the text of snooze time indicator 660 can optionally be orange because the color was selected such that its brightness, intensity, and hue are brighter, more intense, or more attention-grabbing for a user who needs to wake up in the near future.

It should be understood that the particular order in which the operations in FIG. 8 have been described is merely exemplary and is not intended to indicate that the described order is the only order in which the operations could be performed. One of ordinary skill in the art would recognize various ways to reorder the operations described herein.

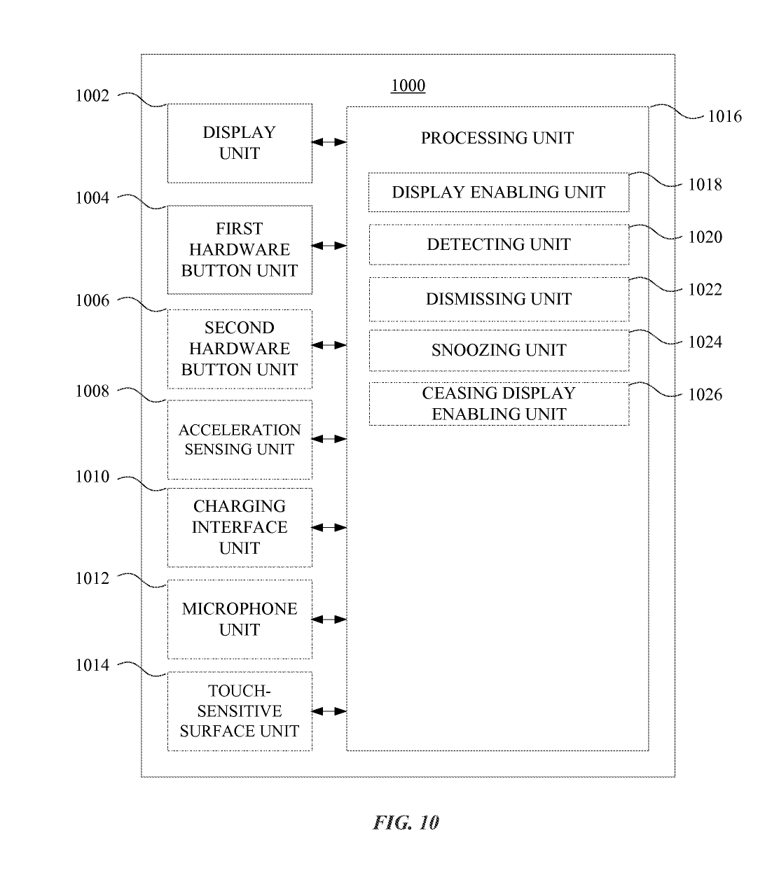

In accordance with some embodiments, FIG. 9 shows an exemplary functional block diagram of an electronic device 900 configured in accordance with the principles of the various described embodiments. In accordance with some embodiments, the functional blocks of electronic device 900 are configured to perform the techniques described above. The functional blocks of the device 900 are, optionally, implemented by hardware, software, or a combination of hardware and software to carry out the principles of the various described examples. It is understood by persons of skill in the art that the functional blocks described in FIG. 9 are, optionally, combined or separated into sub-blocks to implement the principles of the various described examples. Therefore, the description herein optionally supports any possible combination or separation or further definition of the functional blocks described herein.

As shown in FIG. 9, electronic device 900 includes a display unit 902 configured to display a graphic user interface such as a nightstand-mode user interface and/or an alarm user interface, and a battery unit 904 configured to provide power to device 900. Optionally, device 900 also includes a touch-sensitive surface unit 906 configured to receive contacts. Device 900 further includes processing unit 908 coupled to display unit 902, battery unit 904, and, optionally, touch-sensitive surface unit 906. Processing unit 908 contains detecting unit 910 and activating unit 912. Optionally, processing unit 908 further includes display enabling unit 914, suppressing providing unit 916, providing unit 918, ceasing display enabling unit 920, and resuming display enabling unit 922.

Processing unit 912 is configured to: detect (e.g., with detecting unit 910) that the battery unit (e.g., battery unit 904) is being charged; detect (e.g., with detecting unit 910) that the device is oriented in a predefined orientation; and in accordance with the detection that the battery unit (e.g., battery unit 904) is being charged and the detection that the device is oriented in the predefined orientation, activate (e.g., with activating unit 912) a predefined mode of operation.

In some embodiments, detecting (e.g., with detecting unit 910) that the device is in a predefined orientation comprises detecting that a face of the display unit (e.g. display unit 902) of the device is substantially vertical.

In some embodiments, detecting (e.g., with detecting unit 910) that the device is in a predefined orientation comprises detecting that a predefined face of the device is facing substantially upward.

In some embodiments, activating (e.g., with activating unit 912) the predefined mode of operation comprises activating a nightstand mode and enabling display on the display unit of an interface of the nightstand mode.

In some embodiments, activating (e.g., with detecting unit 910) the predefined mode of operation comprises activating a do-not-disturb mode.

In some embodiments, enabling display on the display unit (e.g., display unit 902) of an interface of the nightstand mode comprises enabling display on the display unit (e.g., display unit 902) of a clock face.

In some embodiments, enabling display on the display unit (e.g., display unit 902) of an interface of the nightstand mode comprises enabling display on the display unit (e.g., display unit 902) of a battery indicator

In some embodiments, enabling display on the display unit (e.g., display unit 902) of an interface of the nightstand mode comprises enabling display on the display unit (e.g., display unit 902) of an alarm indicator

In some embodiments, processing unit 908 is further configured to: while nightstand mode is activated: in response to receipt on an incoming notification: suppress providing (e.g., with suppressing providing unit 916) a first notification indicator configured to be provided when nightstand mode is inactive; and provide (e.g., with providing unit 918) a second notification indicator.

In some embodiments, processing unit 908 is further configured to: after a predefined period of time following the activation of the predefined mode of operation, cease to display (e.g., with ceasing display enabling unit 920) on the display unit (e.g., display unit 902) a user interface.

In some embodiments, processing unit 908 is further configured to: resume display (e.g., with resuming display enabling unit 922) of the user interface on the display unit (e.g., display unit 902) at a predetermined time.

In some embodiments, processing unit 908 is further configured to: detect (e.g., with detecting unit 910) a first input; and in response to detecting (e.g., with detecting unit 910) the first input, resume display (e.g., with resuming display enabling unit 922) of the user interface on the display unit (e.g., display unit 902).

In some embodiments, the first input comprises acceleration of the device.

In some embodiments, the acceleration is transmitted to the device through a surface on which the device is resting.

In some embodiments, first the input comprises one or more taps.

The operations described above with reference to FIGS. 7A-7C are, optionally, implemented by components depicted in FIG. 1A, 1B, 2, 3, 4A, 4B, 5A, 5B, 6A, 6B or 9. For example, detecting operations 704 and 706 and activating operation 710 can optionally be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 can optionally utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A, 1B, 2, 3, 4A, 4B, 5A, 5B, 6A, 6B.

In accordance with some embodiments, FIG. 10 shows an exemplary functional block diagram of an electronic device 1000 configured in accordance with the principles of the various described embodiments. In accordance with some embodiments, the functional blocks of electronic device 1000 are configured to perform the techniques described above. The functional blocks of the device 1000 are, optionally, implemented by hardware, software, or a combination of hardware and software to carry out the principles of the various described examples. It is understood by persons of skill in the art that the functional blocks described in FIG. 10 are, optionally, combined or separated into sub-blocks to implement the principles of the various described examples. Therefore, the description herein optionally supports any possible combination or separation or further definition of the functional blocks described herein.

As shown in FIG. 10, electronic device 1000 includes display unit 1002 configured to display a user interface such as a nightstand-mode user interface and/or an alarm user interface, and first hardware button unit 1004 configured to be actuated. Optionally, device 900 also includes second hardware button 1006 configured to be actuated, acceleration sensing unit 1008 configured to sense acceleration, charging interface unit 1010 configured to receive an incoming electrical charge for the device, microphone unit 1012 configured to detect auditory input, and touch-sensitive surface unit 1014 configured to receive contacts. Device 1000 also includes processing unit 1016 coupled to display unit 1002, first hardware button unit 1004, and, optionally, second hardware button 1006, acceleration sensing unit 1008, charging interface unit 1010, microphone unit 1012 and touch-sensitive surface unit 1014. Processing unit 1016 includes display enabling unit 1018, and also optionally includes detecting unit 1020, dismissing unit 1022, snoozing unit 1024, and ceasing display enabling unit 1026.

The processing unit 1016 is configured to: enable displaying (e.g., with display enabling unit 1018) on the display unit (e.g., display unit 1002) a first user interface object in a first color; at a predetermined time: enable displaying (e.g., with display enabling unit 1018) on the display unit (e.g., display unit 1002) the first user interface object in a second color; and enable displaying (e.g., with display enabling unit 1018) on the display unit (e.g., display unit 1002) an option for dismissing an alarm, wherein the option for dismissing is displayed as a second user interface object located at a portion of the display unit (e.g., display unit 1002) proximate to the hardware button unit (e.g., first hardware button unit 1004).

In some embodiments, the processing unit 1016 is further configured to: detect (e.g., with detecting unit 1020) a first input comprising an actuation of the hardware button; and in response to detecting the first input, dismiss (e.g., with dismissing unit 1022) the alarm.

In some embodiments, the processing unit 1016 is further configured to: detect (e.g., with detecting unit 1020) a second input comprising acceleration of the device; and in response to detecting the second input, dismiss (e.g., with dismissing unit 1022) the alarm.

In some embodiments, the processing unit 1016 is further configured to: detect (e.g., with detecting unit 1020) a third input comprising a voice command; and; in response to detecting the third input, dismiss (e.g., with dismissing unit 1022) the alarm.

In some embodiments, the processing unit 1016 is further configured to: detect (e.g., with detecting unit 1020) a fourth input comprising a disconnection of the device from a charging connector; and in response to detecting the fourth input, dismiss (e.g., with dismissing unit 1022) the alarm.

In some embodiments, the processing unit 1016 is further configured to: at the predetermined time: enable displaying (e.g., with display enabling unit 1018) on the display unit (e.g., display unit 1002) an option for snoozing the alarm, wherein the option for snoozing is displayed as a third user interface object located at a portion of the display unit (e.g., display unit 1002) proximate to the second hardware button unit (e.g., second hardware button unit 1006).

In some embodiments, the processing unit 1016 is further configured to: detect (e.g., with detecting unit 1020) a fifth input comprising actuation of the second hardware button; and in response to detecting the fifth input, snooze (e.g., with snoozing unit 1024) the alarm.

In some embodiments, the processing unit 1016 is further configured to: detect (e.g., with detecting unit 1020) a sixth input comprising acceleration of the device; and in response to detecting the sixth input, snooze (e.g., with snoozing unit 1024) the alarm.

In some embodiments, the processing unit 1016 is further configured to: detect (e.g., with detecting unit 1020) a seventh input comprising a voice command; and in response to detecting the seventh input, snooze (e.g., with snoozing unit 1024) the alarm.

In some embodiments, the processing unit 1016 is further configured to: after snoozing the alarm, enable displaying (e.g., with display enabling unit 1018) on the display unit (e.g., display unit 1002) an indication that the alarm has been snoozed, wherein the indication is displayed in the second color.

In some embodiments, enabling displaying (e.g., with display enabling unit 1018) on the display unit (e.g., display unit 1002) an option for dismissing the alarm comprises enabling displaying (e.g., with display enabling unit 1018) on the display unit (e.g., display unit 1002) an animation of the second user interface object moving across the display unit (e.g., display unit 1002) from an edge of the display unit (e.g., display unit 1002) proximate to the first hardware button unit (e.g., first hardware button unit 1004); and enabling displaying (e.g., with display enabling unit 1018) on the display unit (e.g., display unit 1002) an option for snoozing the alarm comprises enabling displaying (e.g., with display enabling unit 1018) on the display unit (e.g., display unit 1002) an animation of the third user interface object moving across the display unit (e.g., display unit 1002) from an edge of the display unit (e.g., display unit 1002) proximate to the second hardware button unit (e.g., second hardware button unit 1006).

In some embodiments, the processing unit 1016 is further configured to: upon dismissing (e.g., with dismissing unit 1022) the alarm, enable displaying (e.g., with display enabling unit 1018) on the display unit (e.g., display unit 1002) a user interface indicating a plurality of notifications.

In some embodiments, the processing unit 1016 is further configured to: detect (e.g., with detecting unit 1020) an eighth input comprising a disconnection of the device from a charging connector; and in response to detecting the eighth input, ceasing to enable displaying (e.g., with ceasing display enabling unit 1026) to enable displaying (e.g., with ceasing display enabling unit 1026) on the display unit (e.g., display unit 1002) the user interface indicating the plurality of notifications.

The operations described above with reference to FIG. 8A-8B are, optionally, implemented by components depicted in FIG. 1A, 1B, 2, 3, 4A, 4B, 5A, 5B, 6A, 6B or 10. For example, displaying operations 804 and 806 and detecting and dismissing operations 810-816, can optionally be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 can optionally utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A non-transitory computer-readable storage medium storing one or more programs, the one or more programs comprising instructions, which when executed by a portable multifunction device with a battery, cause the device to:
detect that the battery is being charged;
detect that the device is oriented in a predefined orientation; and
in accordance with the detection that the battery is being charged and the detection that the device is oriented in the predefined orientation, activate a predefined mode of operation.

2. The non-transitory computer-readable storage medium of claim 1, wherein detecting that the device is in a predefined orientation comprises detecting that a face of the display of the device is substantially vertical.

3. The non-transitory computer-readable storage medium of claim 1, wherein detecting that the device is in a predefined orientation comprises detecting that a predefined face of the device is facing substantially upward.

4. The non-transitory computer-readable storage medium of claim 1, wherein activating the predefined mode of operation comprises activating a nightstand mode and displaying an interface of the nightstand mode.

5. The non-transitory computer-readable storage medium of claim 1, wherein activating the predefined mode of operation comprises activating a do-not-disturb mode.

6. The non-transitory computer-readable storage medium of claim 4, wherein displaying an interface of the nightstand mode comprises displaying a clock face.

7. The non-transitory computer-readable storage medium of claim 4, wherein displaying an interface of the nightstand mode comprises displaying a battery indicator.

8. The non-transitory computer-readable storage medium of claim 4, wherein displaying an interface of the nightstand mode comprises displaying an alarm indicator.

9. The non-transitory computer-readable storage medium of claim 4, wherein the instructions further cause the device to:
while nightstand mode is activated:
in response to receipt on an incoming notification:
suppress providing a first notification indicator configured to be provided when nightstand mode is inactive; and
provide a second notification indicator.

10. The non-transitory computer-readable storage medium of claim 1, wherein the instructions further cause the device to:
after a predefined period of time following the activation of the predefined mode of operation, cease to display a user interface.

11. The non-transitory computer-readable storage medium of claim 10, wherein the instructions further cause the device to:
resume display of the user interface at a predetermined time.

12. The non-transitory computer-readable storage medium of claim 10, wherein the instructions further cause the device to:
detect a first input; and
in response to detecting the first input, resume display of the user interface.

13. The non-transitory computer-readable storage medium of claim 12, wherein the first input comprises acceleration of the device.

14. The non-transitory computer-readable storage medium of claim 13, wherein the acceleration is transmitted to the device through a surface on which the device is resting.

15. The non-transitory computer-readable storage medium of claim 12, wherein first the input comprises one or more taps.

16. The non-transitory computer-readable storage medium of claim 1, wherein the instructions further cause the device to:
while nightstand mode is activated:
detect a second input; and
in response to detecting the second input, display a user interface indicating a plurality of notifications.

17. A method comprising:
at an electronic device with a display, a battery, and one or more processors;
detecting that the battery is being charged;
detecting that the device is oriented in a predefined orientation; and
in accordance with the detection that the battery is being charged and the detection that the device is oriented in the predefined orientation, activating a predefined mode of operation.

18. A device comprising:
a display;
a battery;
one or more processors; and
memory storing instructions that, when executed by the one or more processors, cause the device to:
detect that the battery is being charged;
detect that the device is oriented in a predefined orientation; and
in accordance with the detection that the battery is being charged and the detection that the device is oriented in the predefined orientation, activate a predefined mode of operation.

19. A non-transitory computer-readable storage medium storing one or more programs, the one or more programs comprising instructions, which when executed by a portable multifunction device with a hardware button, cause the device to:
display a first user interface object in a first color;
at a predetermined time:
display the first user interface object in a second color; and
display an option for dismissing an alarm, wherein the option for dismissing is displayed as a second user interface object located at a portion of the display proximate to the a hardware button

20. The non-transitory computer-readable storage medium of claim 19, further comprising instructions for:
detecting a first input comprising an actuation of the hardware button; and
in response to detecting the first input, dismissing the alarm.

21. The non-transitory computer-readable storage medium of claim 19, wherein the instructions further cause the device to:
detect a second input comprising acceleration of the device; and
in response to detecting the second input, dismiss the alarm.

22. The non-transitory computer-readable storage medium of claim 19, wherein the instructions further cause the device to:
detect a third input comprising a voice command; and;
in response to detecting the third input, dismiss the alarm.

23. The non-transitory computer-readable storage medium of claim 19, wherein the instructions further cause the device to:
detect a fourth input comprising a disconnection of the device from a charging connector; and
in response to detecting the fourth input, dismiss the alarm.

24. The non-transitory computer-readable storage medium of claim 19, wherein the device comprises a second hardware button, wherein the instructions further cause the device to:
at the predetermined time:
display an option for snoozing the alarm, wherein the option for snoozing is displayed as a third user interface object located at a portion of the display proximate to the second hardware button.

25. The non-transitory computer-readable storage medium of claim 24, wherein the instructions further cause the device to:
detect a fifth input comprising actuation of the second hardware button; and
in response to detecting the fifth input, snooze the alarm.

26. The non-transitory computer-readable storage medium of claim 24, wherein the instructions further cause the device to:
detect a sixth input comprising acceleration of the device; and
in response to detecting the sixth input, snooze the alarm.

27. The non-transitory computer-readable storage medium of claim 24, wherein the instructions further cause the device to:
detect a seventh input comprising a voice command; and
in response to detecting the seventh input, snooze the alarm.

28. The non-transitory computer-readable storage medium of claim 24, wherein the instructions further cause the device to:
after snoozing the alarm, display an indication that the alarm has been snoozed, wherein the indication is displayed in the second color.

29. The non-transitory computer-readable storage medium of claim 24, wherein:
displaying an option for dismissing the alarm comprises displaying an animation of the second user interface object moving across the display from an edge of the display proximate to the first hardware button; and
displaying an option for snoozing the alarm comprises displaying an animation of the third user interface object moving across the display from an edge of the display proximate to the second hardware button.

30. The non-transitory computer-readable storage medium of claim 20, wherein the instructions further cause the device to:
upon dismissing the alarm, display a user interface indicating a plurality of notifications.

31. The non-transitory computer-readable storage medium of claim 30, wherein the instructions further cause the device to:
detect an eighth input comprising a disconnection of the device from a charging connector; and
in response to detecting the eighth input, cease to display the user interface indicating the plurality of notifications.

32. A method comprising:
at an electronic device with a display, a hardware button, and one or more processors;
displaying a first user interface object in a first color;
at a predetermined time:
displaying the first user interface object in a second color; and
displaying an option for dismissing an alarm, wherein the option for dismissing is displayed as a second user interface object located at a portion of the display proximate to the hardware button.

33. A device comprising:
a display;
a hardware button;
one or more processors; and
memory storing instructions that, when executed by the one or more processors, cause the device to:
display a first user interface object in a first color;
at a predetermined time:
display the first user interface object in a second color; and
display an option for dismissing an alarm, wherein the option for dismissing is displayed as a second user interface object located at a portion of the display proximate to the hardware button.
